(19) United States
(12) Patent Application Publication
(10) Pub. No.: US 2013/0344500 A1
(43) Pub. Date: Dec. 26, 2013

(54) TISSUE ADHESIVE SUBSTRATES

(71) Applicant: ARATOME, LLC, Menlo Park, CA (US)

(72) Inventors: Jay Trautman, Los Altos, CA (US); David P. Lenzi, Menlo Park, CA (US)

(73) Assignee: Aratome, LLC, Menlo Park, CA (US)

(21) Appl. No.: 13/827,076

(22) Filed: Mar. 14, 2013

Related U.S. Application Data
(60) Provisional application No. 61/662,266, filed on Jun. 20, 2012.

(51) Int. Cl. G01N 1/31

(52) U.S. Cl. CPC G01N 1/312
USPC 435/7.1; 422/551

(57) ABSTRACT

Described herein are tissue adhesive substrates and methods of making such substrates. Tissue adhesive substrates comprise a glass substrate and a silane covalently bound to the glass substrate. In some variations, the silane may be an amino silane, and may comprise an aryl or an alkyl moiety. In other variations, the silane may be coated with carbon. Silanes may be deposited onto the glass substrate by vapor deposition. Tissue adhesive substrates comprising carbon-coated silanized glass substrates may be capable of retaining a tissue section through multiple cycles of antibody staining and stripping without discernible or substantial damage to the tissue section. In addition, carbon-coated tissue adhesive substrates may also provide a fiduciary marker for closed-loop autofocussing mechanisms.

### CROSS-REFERENCE TO RELATED APPLICATIONS

This application claims priority to U.S. Provisional Patent Application Ser. No. 61/662,266, filed Jun. 20, 2012, which is hereby incorporated by reference in its entirety.

### BACKGROUND

Tissue samples may be attached to a variety of substrates for immunohistochemical analysis. In some instances, tissue samples may be mounted on glass slides for immunostaining and imaging. One example of an immunostaining technique is array tomography. Array tomography is a fluorescence imaging method for quantitative, molecular characterization of tissues with volume resolution that can exceed the diffraction limit throughout large samples. In array tomography, ribbons of embedded tissue sections are transferred to a glass coverslip or slide, stained with fluorescent dye-labeled antibodies or other reagents, and imaged with a fluorescent microscope. The individual two-dimensional images may then be aligned and stitched into volumetric data. After imaging, the antibodies may be stripped from the tissue sections, and the tissue sections may be stained with additional markers and re-imaged. This process may be performed using four markers at a time, and may be repeated as many times as desired, as long as the tissue section remains intact and adhered to the coverslip.

In practice, producing high quality array tomography data may be hindered by failure in any one of the numerous steps in fabrication, staining, and imaging through multiple iterations. For example, poor tissue adhesion to the glass coverslip across multiple cycles may give rise to incomplete images and data (e.g., gaps in the volume reconstruction). In addition, adhesives or coverslips that do not provide for stable operation of reflection-based autofocus imaging of the tissue section may result in increased imaging time. Slides or coverslips that can retain a tissue section through multiple cycles of antibody staining and stripping may be desirable for this and other immunostaining techniques.

### BRIEF SUMMARY

Described herein are tissue adhesive substrates and methods of making such substrates. Tissue adhesive substrates may comprise a glass substrate and a silane covalently bound to the glass substrate. In some variations, the silane may be an amino silane, and may comprise an aryl or an alkyl moiety. In other variations, the silane may be a silane that is coated with carbon. Silanes may be deposited onto the glass substrate by vapor deposition. Tissue adhesive substrates comprising silanized glass substrates that are coated with carbon may be capable of retaining a tissue section through multiple cycles of antibody staining and stripping without discernible damage to the tissue section. In addition, carbon-coated tissue adhesive substrates may also provide a fiduciary marker for closed-loop autofocussing imaging mechanisms. The tissue adhesive substrates of the invention may be used in array tomography systems and methods, as well as other immunostaining techniques. The carbon-coated tissue adhesive substrates described herein may also be suitable for scanning electron microscopy (SEM). For example, carbon-coated silanized tissue adhesive substrates may allow for the acquisition of SEM images at higher beam energies without damaging the tissue section than carbon-coated subbed substrates.

In one variation, the surface of a glass substrate (e.g. a #1.5H coverslip) may be derivatized with hydroxy- or alkoxy-silanes that are terminated with various functional groups that may have a high affinity for tissue sections. In some embodiments, the functional groups are amine-terminated. The silane moiety may form a covalent bond to the glass substrate such that the functional group is available for adhering a tissue section. The functional groups of the invention may have a high affinity for the embedded tissue sections.

In another variation, the surface of a glass substrate may be derivatized with hydroxy- or alkoxy-silanes that are terminated with various functional groups which may have a high affinity for amorphous carbon. In some embodiments, the functional groups may comprise charged groups, polar groups, aryl groups and/or alkyl groups, and in some aspects, may have a high affinity for amorphous carbon. After silanization, the coverslips may be coated with a thin, e.g., about 1 nm to about 10 nm, layer of carbon, which may be deposited on the coverslip such as by thermal evaporation in a vacuum chamber at low backing pressures (<10-5 Torr). The carbon layer may be conductive, which may allow imaging of the embedded tissue by SEM. Additionally, the carbon layer may be reflective and used as a fiduciary marker for a closed-loop autofocussing imaging mechanism. For example, a carbon layer may be sufficiently reflective such that a tissue section embedded in acrylate resin having a thickness of about 50 nm to about 200 nm (e.g., about 70 nm) may be imaged by a closed-loop reflection-based autofocus system in less than or equal to about 0.5 seconds (for four fluorescence images at one position including both exposure and transfer time). A reflective carbon layer may provide sufficient contrast at the interface between the substrate and the tissue sample for the operation of reflection autofocus, and may be used with systems that utilize near infrared light for imaging. Imaging with near-infrared light may reduce interference with the fluorescence detection, and may reduce bleaching of the tissue section fluorescence.

In one variation, a tissue adhesive substrate may comprise a glass substrate, a silane covalently bound to the glass substrate, and a carbon coating. The silane may be bound and/or deposited to the glass substrate by vapor deposition. The tissue adhesive substrate may be capable of retaining an ultrathin tissue section through at least 12 cycles of antibody staining and stripping without discernible damage to the tissue section. In some variations, the tissue adhesive substrate may be capable of retaining a tissue section through at least 105 cycles of antibody staining and stripping without discernible damage to the tissue section. A process of making a tissue adhesive substrate may comprise the step of covalently binding and/or depositing a silane to a glass substrate by vapor deposition and coating the silane with carbon. A method of using a tissue adhesive substrate may comprise adhering a tissue section to a tissue adhesive substrate having a glass substrate, a silane covalently bound to the glass substrate, and a carbon coating, and contacting the adhered tissue section with one or more fluorescent dye-labeled antibodies. Contacting the adhered tissue section with one or more fluorescent dye-labeled antibodies may comprise applying a first set of one or more fluorescent dye-labeled antibodies to the adhered tissue section, imaging the adhered tissue section, i) treating the adhered tissue section in an elution solution, ii) applying an additional set of one or more fluorescent dye-labeled antibodies to the adhered tissue section, and iii) imaging the adhered tissue section. In some variations, steps i), ii), and iii) may be repeated four or more times. In some aspects, a tissue adhesive substrate may provide a fiduciary marker for a closed-loop autofocussing imaging mechanism. Optionally, the method may further comprise contacting the tissue section with an electron microscopy contrast agent and imaging the tissue section using electron microscopy. For example, after steps i), ii), and iii) are repeated four or more times, an electron microscopy contrast agent may be applied to the adhered tissue section and the adhered tissue section may be imaged using electron microscopy. Optionally in other variations, the method may comprise applying an electron microscopy contrast agent to the adhered tissue section prior to contacting the adhered tissue section with one or more fluorescent dye-labeled antibodies and imaging the adhered tissue section using electron microscopy after contacting the adhered tissue section with one or more fluorescent dye-labeled antibodies. The electron microscopy contrast agent for any of the above methods may comprise a heavy metal, and may include antibodies bound to a heavy metal such as gold-labeled antibodies. Alternatively or additionally, the electron microscopy contrast agent may comprise lead or uranium.

Also described herein are kits. In some variations, a kit may comprise a tissue adhesive substrate comprising a glass substrate and a silane covalently bound to the glass substrate, where the tissue adhesive substrate may be capable of retaining an ultrathin tissue section through at least 5 cycles of antibody staining and stripping, and instructions for using the tissue adhesive substrate. In another variation, a kit may comprise a tissue adhesive substrate comprising a glass substrate, a silane covalently bound to the glass substrate, and a carbon coating, where the tissue adhesive substrate may be capable of retaining an ultrathin tissue section through at least 5 cycles of antibody staining and stripping, and instructions for using the tissue adhesive substrate.

In other variations, an embedded tissue adhesive substrate may comprise a glass substrate and a silane covalently bound to the glass substrate, where the tissue adhesive substrate may be capable of retaining an ultrathin tissue section through at least 5 cycles of antibody staining and stripping without discernible damage to the tissue section. The silane may comprise an aryl or an alkyl moiety, where the aryl or alkyl moiety is substituted with a moiety of the formula —NR^{a}R^{b}(R^{c})ₙ, where n is 0 or 1; R^{a}, R^{b} and R^{c} are independently H or a C₁-C₆ alkyl or two of R^{a}, R^{b} and R^{c} are taken together with the nitrogen to which they are attached to form a five or six-membered heterocyclic nitrogen containing ring; and a counterion X⁻ is present when n is 1. In certain aspects, a C₁-C₆ alkyl may comprise a C₁-C₃ alkyl. In some variations, the silane may be 3-aminopropyltrimethoxysilane. Optionally, the silane may comprise a hydroxyl or alkoxy moiety, and in some variations, the silane may further comprise methoxy or ethoxy moiety. Alternatively, a silane may comprise a C₁-C₆ alkyl moiety substituted with a moiety of the formula —NR^{a}R^{b} where R^{a} and R^{b} are independently H and a C₁-C₆ alkyl. In some variations, a silane is of the formula (I):

Si(OR¹)₃(R²) (I)

where each R¹ is independently H, a C₁-C₆alkyl, a bond to the glass substrate, or is taken together with an OR¹ moiety from a neighboring silane to provide an ester cross-linked silane multimer, R² is an aryl or an alkyl moiety, where the aryl or alkyl moiety is substituted with a moiety of the formula —NR^{a}R^{b}(R^{c})ₙ, where n is 0 or 1; R^{a}, R^{b} and R^{c} are independently H or a C₁-C₆ alkyl or two of R^{a}, R^{b} and R^{c} are taken together with the nitrogen to which they are attached to form a five or six-membered heterocyclic nitrogen containing ring; and a counterion X⁻ is present when n is 1. In some variations, R² is a C₁-C₆ alkyl substituted with a moiety of the formula —NR^{a}R^{b}(R^{c})ₙ, where: n is 0 or 1; R^{a}, R^{b} and R^{c} are independently H or a C₁-C₆ alkyl; and a counterion X⁻ is present when n is 1. In certain embodiments, the silane may be deposited on the glass substrate by vapor deposition.

In certain embodiments, a process of making a tissue adhesive substrate may comprise the step of covalently binding a silane to a glass substrate by vapor deposition, where the silane comprises an aryl or an alkyl moiety and where the aryl or alkyl moiety is substituted with a moiety of the formula —NR^{a}R^{b}(R^{c})ₙ, where n is 0 or 1; R^{a}, R^{b} and R^{c} are independently H or a C₁-C₆ alkyl or two of R^{a}, R^{b} and R^{c} are taken together with the nitrogen to which they are attached to form a five or six-membered heterocyclic nitrogen containing ring; and a counterion X⁻ is present when n is 1. In certain aspects, a C₁-C₆ alkyl may comprise a C₁-C₃ alkyl. A tissue adhesive substrate made according to the above process may be capable of retaining an ultrathin tissue section through at least 5 cycles of antibody staining and stripping without discernible damage to the tissue section.

In some variations, a method of using a tissue adhesive substrate may comprise adhering a tissue section to a tissue adhesive substrate comprising a glass substrate and a silane covalently bound to the glass substrate, the silane comprising an aryl or an alkyl moiety, where the aryl or alkyl moiety is substituted with a moiety of the formula —NR^{a}R^{b}(R^{c})ₙ, where n is 0 or 1; R^{a}, R^{b} and R^{c} are independently H or a C₁-C₆ alkyl or two of R^{a}, R^{b} and R^{c} are taken together with the nitrogen to which they are attached to form a five or six-membered heterocyclic nitrogen containing ring; and a counterion X⁻ is present when n is 1, where the tissue adhesive substrate is capable of retaining an ultrathin tissue section through at least 5 cycles of antibody staining and stripping without discernible damage to the tissue section, and contacting the adhered tissue section with one or more fluorescent dye-labeled antibodies. In some variations, the adhered tissue section may be contacted with four or more fluorescent dye-labeled antibodies. In certain aspects, contacting the adhered tissue section with one or more fluorescent dye-labeled antibodies may comprise applying a first set of one or more fluorescent dye-labeled antibodies to the adhered tissue section, imaging the adhered tissue section, i) treating the adhered tissue section in an elution solution, ii) applying an additional set of one or more fluorescent dye-labeled antibodies to the adhered tissue section, and iii) imaging the adhered tissue section. Optionally, steps i), ii) and iii) may be repeated three or more times. In some variations, the adhered tissue section may be contacted with 12 or more fluorescent dye-labeled antibodies. Contacting the adhered tissue section with one or more fluorescent dye-labeled antibodies may comprise applying sets of fluorescent dye-labeled antibodies to the adhered tissue section and treating the adhered tissue section in an elution solution between each application of a set of fluorescent dye-labeled antibodies. In some methods, 12 or more fluorescent dye-labeled antibodies may be sequentially applied to the adhered tissue section, where the adhered tissue section is treated in the elution solution for approximately twenty minutes between each application of the fluorescent dye-labeled antibodies. Optionally, the methods described herein may further comprise imaging the adhered tissue section. Imaging the adhered tissue section may comprise imaging the tissue section using a light microscope. In some variations, the tissue section may be imaged using visible light, and/or ultraviolet light, and/or near-infrared light. In any of the methods described herein, the tissue section may remain adhered to the tissue adhesive substrate through all the steps of the method.

In some variations, a method of using a tissue adhesive substrate may further comprise the step of making the tissue adhesive substrate prior to adhering the tissue section to the tissue adhesive substrate, where making the tissue adhesive substrate may comprise the step of covalently binding a silane to a glass substrate by vapor deposition, where the silane comprises an aryl or an alkyl moiety, where the aryl or alkyl moiety is substituted with a moiety of the formula —NR^{a}R^{b}(R^{c})ₙ, where n is 0 or 1; R^{a}, R^{b} and R^{c} are independently H or a C₁-C₆ alkyl or two of R^{a}, R^{b} and R^{c} are taken together with the nitrogen to which they are attached to form a five or six-membered heterocyclic nitrogen containing ring; and a counterion X⁻ is present when n is 1. In certain aspects, a C₁-C₆ alkyl may comprise a C₁-C₃ alkyl.

Any of the tissue adhesive substrates described herein may further comprise a carbon coating. In some variations, the tissue adhesive substrate may further comprise a tissue section adhered to the silane.

In some variations, a tissue adhesive substrate may comprise a glass substrate, a silane covalently bound to the glass substrate, the silane comprising a functional group that has an affinity for amorphous carbon, and a carbon coating. The silane may be bound to the glass substrate by vapor deposition. The silane may comprise a hydroxyl or alkoxy moiety, and may optionally comprise a methoxy or ethoxy moiety. In certain embodiments, a tissue adhesive substrate may comprise a silane comprising an aryl or an alkyl moiety, where the aryl or alkyl moiety may be substituted with a moiety of the formula —NR^{a}R^{b}(R^{c})ₙ, where n is 0 or 1; R^{a}, R^{b} and R^{c} are independently H or a C₁-C₆ alkyl or two of R^{a}, R^{b} and R^{c} are taken together with the nitrogen to which they are attached to form a five or six-membered heterocyclic nitrogen containing ring; and a counterion X⁻ is present when n is 1. In certain aspects, a C₁-C₆ alkyl may comprise a C₁-C₃ alkyl. In embodiments where n is 1, the aryl or alkyl moiety may be substituted with a moiety selected from the group consisting of: a moiety of the formula —NH₃⁺Cl⁻ and a moiety of the formula (II):

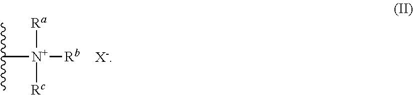

In some variations, the silane may comprise a C₁-C₆ alkyl moiety substituted with an amino moiety of the formula —NR^{a}R^{b} where R^{a} and R^{b} are independently H and a C₁-C₆alkyl. In some variations, the tissue adhesive substrate may comprise a silane selected from the group consisting of: hexyltriethoxysilane, propyldimethylmethoxysilane, benzyltriethoxysilane, phenethyltrimethoxysilane, 3-aminopropyltrimethoxysilane, N-(2-aminoethyl)-3-aminopropyltrimethoxysilane, 3-(trihydroxylsilyl)-1-propane-sulfonic acid, bis(2-hydroxyethyl)-3-aminopropyltriethoxysilane, isocyanatopropyl-trimethoxy-silane, and N-trimethoxysilylpropyl-N,N,N-trimethylammonium chloride. A silane may be bound to the glass substrate by thirty-minute or sixty-minute vapor deposition.

In some variations, a tissue adhesive substrate comprising a glass substrate, a silane comprising a functional group that has an affinity for amorphous carbon, and a carbon coating may be capable of retaining an ultrathin tissue section through at least 12 cycles of antibody staining and stripping without discernible damage to the tissue section. In some variations, the tissue adhesive substrate may be capable of retaining a tissue section through at least 105 cycles of antibody staining and stripping without discernible damage to the tissue section. One variation of a process of making a tissue adhesive substrate may comprise the step of covalently binding a silane to a glass substrate by vapor deposition, where the silane comprises a functional group that has an affinity for amorphous carbon, and coating the silane covalently bound to the glass substrate with carbon. In some embodiments, the tissue adhesive substrate made by this process is capable of retaining an ultrathin tissue section through at least 12 antibody staining and stripping cycles without discernible damage to the tissue section. In some variations, the tissue adhesive substrate may be capable of retaining a tissue section through at 12 cycles of antibody staining and stripping without discernible damage to the tissue section. In some variations, the tissue adhesive substrate may be capable of retaining a tissue section through at least 105 cycles of antibody staining and stripping without discernible damage to the tissue section.

In certain aspects, a method of using a tissue adhesive substrate may comprise adhering a tissue section to a tissue adhesive substrate, and contacting the adhered tissue section with one or more fluorescent dye-labeled antibodies. The tissue adhesive substrate may comprise a glass substrate, a silane covalently bound to the glass substrate, and a carbon coating, where the silane comprises a functional group that has an affinity for amorphous carbon. In some variations, the adhered tissue section may be contacted with four or more fluorescent dye-labeled antibodies. Contacting the adhered tissue section with one or more fluorescent dye-labeled antibodies may comprise applying a first set of one or more fluorescent dye-labeled antibodies to the adhered tissue section, imaging the adhered tissue section, i) treating the adhered tissue section in an elution solution, ii) applying an additional set of one or more fluorescent dye-labeled antibodies to the adhered tissue section, and iii) imaging the adhered tissue section. Optionally, steps i), ii), and iii) may be repeated as many times as desired (e.g., eleven or more times). For example, in some methods, the adhered tissue section may be contacted with 12 or more fluorescent dye-labeled antibodies. In certain aspects, contacting the adhered tissue section with 12 or more fluorescent dye-labeled antibodies may comprise applying 12 or more fluorescent dye-labeled antibodies to the adhered tissue section and treating the adhered tissue section in an elution solution between each application of the fluorescent dye-labeled antibodies. Alternatively or additionally, 12 or more fluorescent dye-labeled antibodies may be sequentially applied to the adhered tissue section, where the adhered tissue section may be treated in the elution solution for approximately twenty minutes between each application of the fluorescent dye-labeled antibodies.

In some embodiments, a method of using a tissue adhesive substrate may further comprise imaging the adhered tissue section. For example, imaging the adhered tissue section may comprise imaging the tissue section using a light microscope. The tissue section may be imaged using visible light, and/or ultraviolet light, and/or infrared light. In any of the methods described herein, the tissue section may remain adhered to the tissue adhesive substrate through all the steps of the method.

In certain embodiments, a method of using a tissue adhesive substrate may further comprise the step of making the tissue adhesive substrate prior to adhering the tissue section to the tissue adhesive substrate. The step of making the tissue adhesive substrate may comprise the steps of covalently binding a silane to a glass substrate by vapor deposition, where the silane comprises a functional group that has an affinity for amorphous carbon and coating the silane bound to the glass substrate with carbon. In some variations, the tissue adhesive substrate may further comprise a tissue section adhered to the carbon.

The tissue adhesive substrate described herein may provide a fiduciary marker for a closed-loop autofocussing imaging mechanism. In some variations, the tissue adhesive substrate may have a refractive index that is different from the refractive index of the tissue section. In some variations, the contrast between the tissue adhesive substrate and the adhered tissue section may be sufficient for the operation of a closed-loop reflection-based autofocussing mechanism. In certain aspects, a tissue adhesive substrate may be capable of reflecting near-infrared light.

Also described herein are kits. A kit may comprise a tissue adhesive substrate, where the tissue adhesive substrate is capable of retaining an ultrathin tissue section through at least 5 cycles of antibody staining and stripping, and instructions for using the tissue adhesive substrate. The tissue adhesive substrate may comprise a glass substrate and a silane covalently bound to the glass substrate, where the silane may comprise an aryl or an alkyl moiety, where the aryl or alkyl moiety is substituted with a moiety of the formula —NR^{a}R^{b}(R^{c})ₙ, where n is 0 or 1; R^{a}, R^{b} and R^{c} are independently H or a C₁-C₆ alkyl or two of R^{a}, R^{b} and R^{c} are taken together with the nitrogen to which they are attached to form a five or six-membered heterocyclic nitrogen containing ring; and a counterion X⁻ is present when n is 1. In certain aspects, a C₁-C₆ alkyl may comprise a C₁-C₃ alkyl. Optionally, the tissue adhesive substrate may further comprise a carbon coating. In some variations, the tissue adhesive substrate may comprise a glass substrate, a silane covalently bound and/or deposited on the glass substrate, and a carbon coating. In some aspects, the silane may have an affinity for amorphous carbon. In certain variations, the instructions may be for adhering the ultrathin tissue section to the tissue adhesive substrate and contacting the adhered ultrathin tissue section with an antibody.

Another variation of a method of using a tissue adhesive substrate may comprise adhering a tissue section to a tissue adhesive substrate comprising a glass substrate, a silane covalently bound to the glass substrate, and a carbon coating, contacting the adhered tissue section with one or more fluorescent dye-labeled antibodies, and contacting the adhered tissue section with an electron microscopy contrast agent. In some variations, the electron microscopy contrast may comprise a heavy metal. For example, the electron microscopy contrast agent may comprise antibodies bound to heavy metals, including gold-labeled antibodies. In some variations, the heavy metal may comprise uranium or lead.

Also described herein is a method of using a tissue adhesive substrate comprising adhering a tissue section to a tissue adhesive substrate comprising a glass substrate, a silane covalently bound to the glass substrate, and a carbon coating, contacting the adhered tissue section with one or more electron microscopy contrast agents, and imaging the adhered tissue section using electron microscopy.

### BRIEF DESCRIPTION OF THE DRAWINGS

FIG. 1 depicts one variation of a method of making a silanized tissue adhesive substrate.

FIG. 2 depicts another variation of a method of making a silanized tissue adhesive substrate.

FIG. 3 depicts one variation of a method of making a carbon-coated silanized tissue adhesive substrate.

FIG. 4 depicts one variation of a method of using a tissue adhesive substrate for an immunohistochemical analysis.

FIG. 5 depicts one variation of a method for evaluating an embedded tissue sample adhered to a tissue adhesive substrate after one or more elution cycles.

FIG. 6 depicts a table that describes the adhesion endurance for tissue sections on different tissue adhesive substrates after repeated elution cycles

FIGS. 7A to 7I depict micrographs of tissue sections on different tissue adhesive substrates after repeated elution cycles. FIGS. 7A, 7D, and 7G depict micrographs of tissue sections on different tissue adhesive substrates (subbed, commercial amino silane treated, 4-hr vapor deposited 3-aminopropyltrimethoxysilane substrates, respectively) prior to any elution cycles. FIGS. 7B and 7E depict the tissue sections and substrates of FIGS. 7A and 7D, respectively, after 4 elution cycles, and FIG. 7H depict the tissue section and substrate of FIG. 7G after 12 elution cycles. FIGS. 7C, 7F and 7I depict enlargements of a portion of FIGS. 7B, 7E and 7H, respectively. Tissue areas are indicated by a “T” and resin areas by a “R”. Long arrows denote cracking in tissue areas and short arrows denote cracking in resin areas.

FIG. 8 depicts a table that describes the adhesion endurance for tissue sections on different carbon-coated tissue adhesive substrates after repeated elution cycles.

FIGS. 9A to 9J depict phase-contrast micrographs of tissue sections on different carbon-coated tissue adhesive substrates after repeated elution cycles. Panel-a of FIGS. 9A to 9J depict micrographs of tissue sections on different tissue adhesive substrates (as described in the table of FIG. 8) prior to any elution cycles. Panel-b of FIGS. 9A to 9J depict tissue sections and substrates after repeated elution cycles. FIG. 9A-b depicts the tissue section and substrate of FIG. 9A-a after 8 elution cycles. FIGS. 9B-b, 9E-b, 9F-b, 9G-b, 9I-b, 9J-b depict the tissue sections and substrates of FIGS. 9B-a, 9E-a, 9F-a, 9G-a, 9I-a, 9J-a, respectively, after 12 elution cycles. FIG. 9D-b depicts the tissue section and substrate after 13 elution cycles. FIG. 9H-b depicts the tissue section and substrate of FIG. 9H-a after 14 elution cycles. FIG. 9C-b depicts the tissue section and substrate of FIG. 9C-a after 17 elution cycles. Panel-c of FIGS. 9A to 9J depict enlargements of a region of panel-b. Vertical arrows denote cracking in the carbon coating, horizontal arrows denote tissue cracking, triangles denotes pinholes in resin-only regions, and chevrons denote peeling and lifting of the carbon coating.

FIG. 10 depicts a table that describes the adhesion endurance of embedded tissue sections on different tissue adhesive substrates (with and without a carbon coating) after repeated elution cycles.

FIGS. 11A and 11B depict electron micrographs of tissue sections adhered to a carbon-coated subbed glass substrate that have been damaged during electron microscopy. FIG. 11C depicts an electron micrograph of a tissue section adhered to a carbon-coated silanized glass substrate that remained intact during electron microscopy.

### DETAILED DESCRIPTION

Described herein are tissue adhesive substrates and methods of making such substrates. Tissue adhesive substrates may comprise a glass substrate and a silane covalently bound to the glass substrate. In some variations, the silane may be an amino silane, and may comprise an aryl or an alkyl moiety. In other variations, the silane covalently bound to the glass substrate may be coated with carbon. Silanes may be deposited onto the glass substrate by vapor deposition. Tissue adhesive substrates comprising carbon-coated silanized glass substrates may be capable of retaining a tissue section through multiple cycles of antibody staining and stripping without discernible and/or substantial damage to the tissue section. In addition, carbon-coated tissue adhesive substrates may also provide a fiduciary marker for closed-loop autofocussing imaging mechanisms. The tissue adhesive substrates described herein may be used in array tomography systems and methods.

Array tomography is a fluorescence imaging method for quantitative, molecular characterization of tissues with volume resolution more than an order of magnitude better than confocal microscopy, throughout large samples. As currently practiced, the Array Tomography process consists of the following steps: (1) tissue fixation; (2) tissue dissection and resin embedding; (3) mounting the resin-embedded specimen block in an ultramicrotome chuck; (4) application of an adhesive to the top and bottom of the block, which results in stable splices between successive sections as they are cut serially by the diamond knife; (5) automated cycling of the ultramicrotome to produce a ribbon that floats into an adjacent water trough; (6) manual transfer of the ribbon from the trough to the surface of a coated, precision glass coverslip; (7) staining of the ribbon of tissue sections with fluorescent dye-labeled antibodies or other reagents; (8) imaging with a fluorescence microscope; (9) aligning, warping and stitching the individual two-dimensional images into volumetric data; (10) for more than four markers, the antibodies are stripped, the array of tissue sections stained with additional markers and re-imaged; this step is repeated as many times as desired, limited by the stable association of the embedded tissue to the coverslip. For example, an array tomography procedure with nine cycles, where four fluorescent labels are applied per cycle, thirty-six antigens may be assayed. Additional details regarding array tomography are described in various studies, which are each hereby incorporated by reference in its entirety (Micheva, K D and Smith, S J (2007) Array Tomography: A New Tool for Imaging the Molecular Architecture and Ultrastructure of Neural Circuits, Neuron 55 25-36; Micheva, K D, O'Rourke, N, Busse, B and Smith S J, Array tomography: production of arrays, Cold Spring Harbor Protocols 2010:doi:10.1101/pdb.prot5524. Adapted from Imaging: A Laboratory Manual (ed. Yuste). CSHL Press, Cold Spring Harbor, N.Y., USA, 2010; Micheva, K D, Busse, B, N C Weiler, O'Rourke, N and Smith S J (2010) Single-Synapse Analysis of a Diverse Synapse Population: Proteomic Imaging Methods and Markers, Neuron 68, 639-653).

In practice, producing high quality array tomography data may be hindered by failure in any one of the numerous steps in fabrication, staining, and imaging through multiple iterations. For example, poor tissue adhesion to the glass coverslip across multiple cycles may give rise to incomplete images and data (e.g., gaps in the volume reconstruction). In addition, tissue adhesives that do not provide sufficient contrast between the coverslip and the tissue section for the operation of a reflection-based autofocus mechanism may increase imaging time. Disclosed herein are tissue adhesive substrates that comprise a silane covalently bound to a silica surface (such as a glass substrate), which may provide improved tissue adhesion for multiple cycles of antibody staining and stripping. Some of variations of tissue adhesive substrates also provide an optical interface that may allow for reliable use of fast reflection-based autofocus methods. Some variations of tissue adhesive substrates may also allow for the acquisition of electron microscopy (e.g. SEM, REM) images without degrading and/or damaging the tissue section. For example, a carbon-coated silanized tissue adhesive substrate may allow for electron microscopy (EM) imaging of a tissue section at higher beam energies with less accompanying tissue degradation as compared to imaging of a tissue section adhered to a carbon-coated subbed tissue adhesive substrate. Also disclosed herein are methods of making such tissue adhesive substrates.

One variation of a tissue adhesive substrate may comprise a glass substrate and a silane covalently bound to the glass substrate. A silane that is capable of binding the glass substrate and presenting a functional group that has an affinity for a tissue section may thus be employed. A silane has an affinity for a tissue section if the silane is capable of binding to or otherwise interacting with the tissue section. Methods of assessing affinity are known and include the methods detailed herein. In one aspect, the silane is a hydroxy- or alkoxy-silane comprising a functional group having an affinity for a tissue section, where the functional group is a charged group, a polar group, an aryl group or an alkyl group. In a further aspect, the silane is a hydroxy- or alkoxy-silane (e.g., a trihydroxy-, trimethoxy- or triethoxy-silane) comprising a functional group having an affinity for a tissue section, such as a charged group, a polar group, an aryl group or an alkyl group.

As used herein, “alkyl” refers to and includes saturated linear or branched univalent hydrocarbon structures and combinations thereof. Particular alkyl groups are those having 1 to 20 carbon atoms (a “C₁-C₂₀ alkyl”). More particular alkyl groups are those having 1 to 8 carbon atoms (a “C₁-C₈ alkyl”) or 1 to 6 carbon atoms (a “C₁-C₆ alkyl”) or 1 to 3 carbon atoms (a “C₁-C₃ alkyl”). When an alkyl residue having a specific number of carbons is named, all geometric isomers having that number of carbons are intended to be encompassed and described; thus, for example, “butyl” is meant to include n-butyl, sec-butyl, iso-butyl, tert-butyl and cyclobutyl.

“Alkylene” refers to the same residues as alkyl, but having bivalency. Examples of alkylene include methylene (—CH2-), ethylene (—CH2CH2-), propylene (—CH2CH2CH2-) and butylene (—CH2CH2CH2CH2-).

“Alkoxy” as used herein refers to an —O-alkyl moiety. The alkoxy in one aspect is an alkoxy of the formula —O—C₁-C₆alkyl. Examples of alkoxy include methoxy (—O—CH₃) and ethoxy (—O—CH₂CH₃).

“Aryl” refers to an unsaturated aromatic carbocyclic group (e.g., phenyl). In one variation, the aryl group contains from 6 to 14 annular carbon atoms.

A silane (e.g., a hydroxy- or alkoxy-silane) may comprise an alkyl or an aryl group as the functional group having an affinity for a tissue section. For example, a silane as detailed herein in one aspect comprises a C₁-C₈ alkyl as the functional group, such as in propyldimethylmethoxysilane or hexyltriethoxysilane. In another aspect, a silane may comprise an aryl group as the functional group having affinity for a tissue section. The aryl group in one aspect is phenyl. It is understood that the aryl functional group (e.g., phenyl) may be bound to the silane via a linker, such as a C₁-C₃ or a C₁-C₆ alkylene linker, as exemplified in benzyltriethoxysilane or phenethyltrimethoxysilane.

A silane (e.g., a hydroxy- or alkoxy-silane) may comprise a polar group as the functional group having an affinity for a tissue section. The polar group in one aspect is a nitrogen or sulfur containing group, such as an amino group, sulfonyl group and isocyanato group, which may be bound to the silane via a linker, such as a C₁-C₃ or a C₁-C₆ alkylene linker, as exemplified in 3-aminopropyltrimethoxysilane, 3-(trihydroxylsilyl)-1-propane-sulfonic acid and isocyanatoproyl-trimethoxy-silane. A silane (e.g., a hydroxy- or alkoxy-silane) in one variation may comprise a charged moiety, such as a moiety containing a positively charged quaternary nitrogen and a counter anion (e.g., a silane comprising the moiety —N(CH₃)₃⁺Cl⁻). In some variations, a silane may comprise a functional group having an affinity for amorphous carbon.

A silane (e.g., a hydroxy- or alkoxy-silane) comprising an amino group as the functional group having an affinity for a tissue section is referred to herein as an amino silane. It is understood that the amino group of an amino silane may be bound to the silane via a linker moiety, such as a C₁-C₃ or a C₁-C₆ alkylene linker, as exemplified in 3-aminopropyltrimethoxysilane. The silane may be an amino silane, and in some variations, may comprise an aryl or an alkyl moiety. In one aspect, the silane may be a hydroxy- or alkoxy-silane (e.g., a trihydroxy-, trimethoxy- or triethoxy-silane) comprising an amino functional group. The amino silane (e.g., an amino containing trihydroxy-, trimethoxy- or triethoxy-silane) may present the amino moiety as a terminal functional group bound to an alkylene or aryl moiety. For example, a silane comprising an aminoalkylene moiety (such as an aminopropyl moiety) may be employed as detailed herein.

In one variation, the silane comprises an aryl or an alkyl moiety, where the aryl or alkyl moiety is substituted with a moiety of the formula —NR^{a}R^{b}(R^{c})ₙ, where n is 0 or 1; R^{a}, R^{b} and R^{c} are independently H or a C₁-C₆ alkyl or two of R^{a}, R^{b} and R^{c} are taken together with the nitrogen to which they are attached to form a five or six-membered heterocyclic nitrogen containing ring; and a counterion X⁻ is present when n is 1. In one aspect, the silane comprises an alkyl moiety substituted with a moiety of the formula —NR^{a}R^{b}(R^{c})ₙ, such as a C₁-C₆ alkyl moiety, which in one aspect is a propyl moiety substituted with a moiety of the formula —NR^{a}R^{b}(R^{c})ₙ. In certain aspects, a C₁-C₆ alkyl may comprise a C₁-C₃ alkyl. In one aspect, the silane may comprise an aryl moiety substituted with a moiety of the formula —NR^{a}R^{b}(R^{c})ₙ. The silane may further comprise a hydroxyl and/or alkoxy moiety (such as a methoxy or ethoxy moiety), such as when the amino silane is trihydroxy-, trimethoxy- or triethoxy-amino silane (e.g., 3-aminopropyltrimethoxysilane). It is understood that when n is 0, the amino silane comprises a moiety of the formula —NR^{a}R^{b}. In a particular variation, an amino silane provided herein comprises a moiety of the formula —NR^{a}R^{b} where R^{a} and R^{b} are independently H and a C₁-C₆ alkyl. In a particular variation, an amino silane comprises a C₁-C₆ alkyl moiety substituted with a moiety of the formula —NR^{a}R^{b}, such as when a trihydroxy-, trimethoxy- or triethoxy-silane comprises a moiety of the formula —C₁-C₆ alkyl-NR^{a}R^{b}.

In another variation, the silane is of the formula (I):

Si(OR¹)₃(R²) (I)

Where each R¹ is independently H, a C₁-C₆alkyl, a bond to the glass substrate, or is taken together with an OR¹ moiety from a neighboring silane to provide an ester cross-linked silane multimer; R² is an aryl or an alkyl moiety, where the aryl or alkyl moiety is substituted with a moiety of the formula —NR^{a}R^{b}(R^{c})ₙ, where n is 0 or 1; R^{a}, R^{b} and R^{c} are independently H or a C₁-C₆ alkyl or two of R^{a}, R^{b} and R^{c} are taken together with the nitrogen to which they are attached to form a five or six-membered heterocyclic nitrogen containing ring; and a counterion X⁻ is present when n is 1. In a particular variation, R² is a C₁-C₆ alkyl substituted with a moiety of the formula —NR^{a}R^{b}(R^{c})ₙ, where: n is 0 or 1; R^{a}, R^{b} and R^{c} are independently H or a C₁-C₆ alkyl; and a counterion X⁻ is present when n is 1. In one aspect, n is 1 and the counterion X⁻ is chloride. In certain aspects, a C₁-C₆ alkyl may comprise a C₁-C₃ alkyl. In a particular variation, n is 1 and R² is an aryl or an alkyl moiety substituted with a moiety of the formula —NH₃⁺Cl⁻ (e.g., R² may be a C₁-C₆ alkyl such as propyl and the amino silane may comprise the moiety —CH₂CH₂CH₂—NH₃⁺Cl⁻). In another variation, n is 0.

Suitable silanes are detailed throughout, including the specific silanes listed in the Tables and in the Examples. The silane in one variation is selected from the group consisting of: hexyltriethoxysilane, propyldimethylmethoxysilane, benzyltriethoxysilane, phenethyltrimethoxysilane, 3-aminopropyltrimethoxysilane, N-(2-aminoethyl)-3-aminopropyltrimethoxysilane, 3-(trihydroxylsilyl)-1-propane-sulfonic acid, bis(2-hydroxyethyl)-3-aminopropyltriethoxysilane, isocyanatopropyl-trimethoxy-silane, and N-trimethoxysilylpropyl-N,N,N-trimethylammonium chloride. In some variations, silanes may be commercially obtained and/or made by commercial vendors, for example, Gelest, Inc. (www.gelest.com).

Any of the silanes detailed herein may in one aspect be coated with carbon. In some variations, a silane may comprise a functional group with an affinity for amorphous carbon. It is understood that each silane provided herein in one variation is carbon coated and may be used in the methods provided as carbon coated silanes. In a particular variation, a tissue adhesive substrate comprises a glass substrate and a carbon-coated silane covalently bound to the glass substrate.

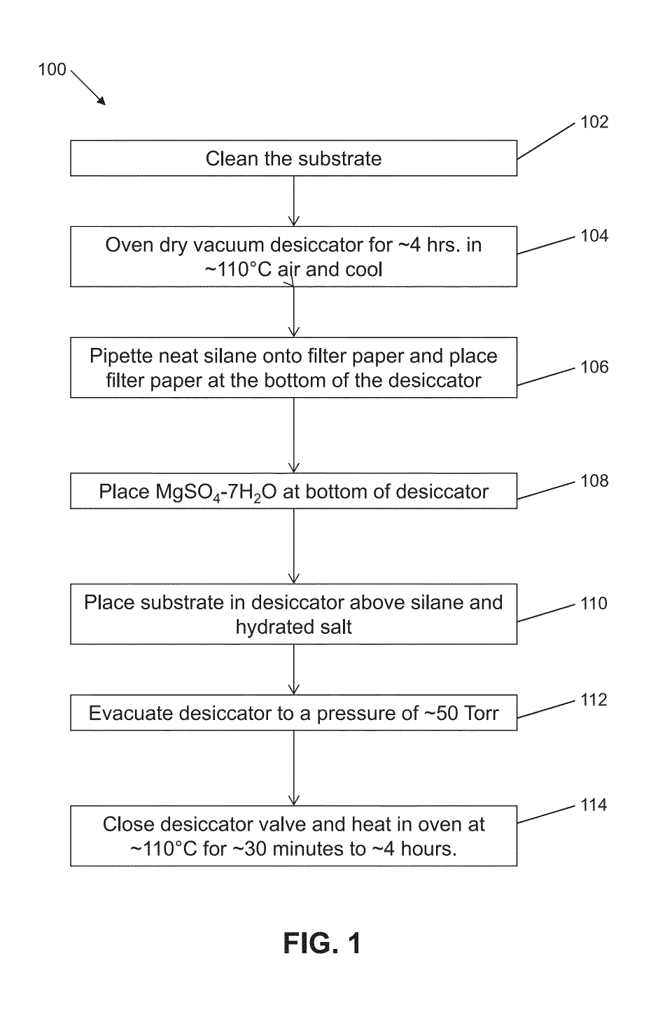

A tissue adhesive substrate comprising a glass substrate and a silane (such as an amino silane or any of the silanes described above) covalently bound to the glass substrate may be made using any suitable method. One example of a method 100 for making a silanized tissue adhesive substrate may comprise covalently binding the silane to and/or depositing the silane on a glass substrate by vapor deposition, as depicted in FIG. 1. The method 100 may comprise the step 102 of cleaning the substrate. For example, one or more glass substrates may be cleaned by immersing the substrate in NaOH (2.5 M) solution for 24 hours, sonicating the glass substrate in water for 10 minutes, immersing the substrate in HCl (0.1 M) for 15 minutes, sonicating the substrate again in water for 10 minutes, and baking the substrate at 110° C. for 15 minutes. Method 100 may further comprise the step 104 of oven-drying a desiccator for vapor deposition. In some variations, oven-drying a desiccator may comprise procuring a 2-liter glass vacuum desiccator fitted with a Teflon stopcock and oven-drying the desiccator for up to 4 hours at 110° C. in air. The desiccator may be cooled before use. Step 106 may comprise providing a silane source for vapor deposition. In some aspects, this may comprise pipetting neat silane (e.g., about 300 μL) onto filter paper (e.g., Whatman filter paper), and placing the filter paper in the bottom of the desiccator. Step 108 may comprise placing 0 to 1.6 g of MgSO₄-7H₂O (Sigma-Aldrich, ACS grade) within the desiccator. For example, MgSO₄.7H₂O may be placed in a foil boat that is placed at the bottom of the desiccator. Step 110 may comprise placing the substrates on a metal rack supported above the silane and hydrated salt. Step 112 may comprise evacuating the desiccator with a mechanical pump to a pressure of ˜50 Torr. Then, in step 114, the Teflon valve of the desiccator may be closed and the desiccator may be placed in an oven preheated to 110° C. (Form a Scientific) for 30 minutes to 4 hours (e.g., 10 minutes, 30 minutes, 40 minutes, 60 minutes, 90 minutes, 2 hours, 3 hours, 4 hours, etc.). Additional methods of silanization using vapor deposition are described elsewhere, such as in “Deposition of Dense Siloxane Monolayers from Water and Trimethoxyorganosilane Vapor” by Lowe, R D, Pellow, M A, Stack, T D P and Chidsey, C E D (2011), Langmuir 27 9928-9935, which is hereby incorporated by reference in its entirety. Without being bound by theory, depositing a silane by vapor deposition may provide a uniform surface to which a tissue section may adhere.

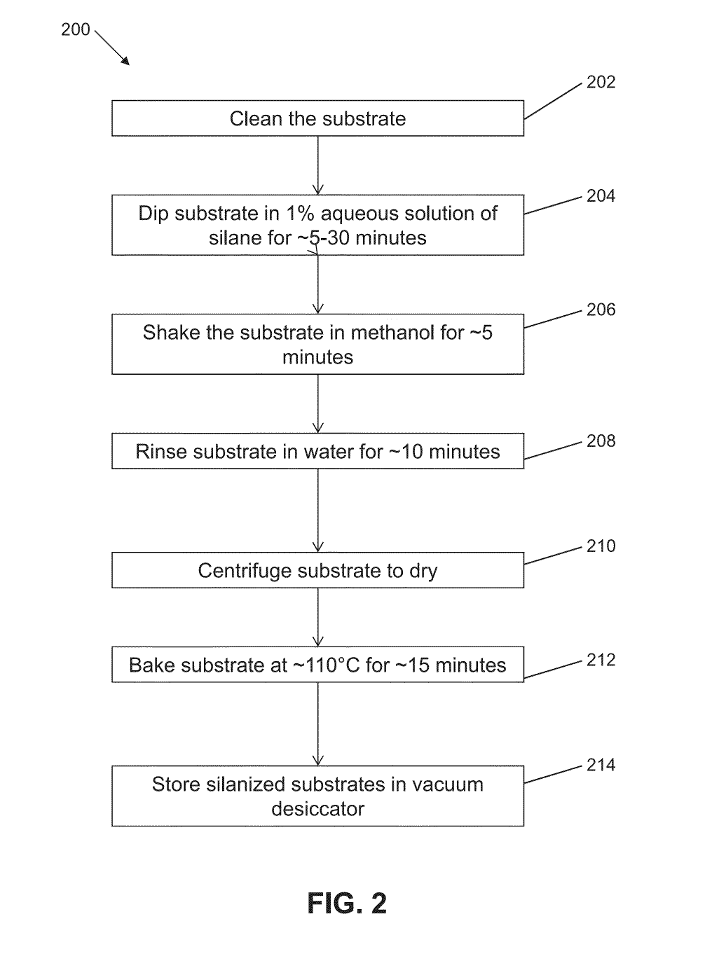

Another example of a method 200 for making a tissue adhesive substrate comprising an amino silane may comprise covalently binding the silane to a glass substrate by immersion, as depicted in FIG. 2. The method 200 may comprise the step 202 of cleaning the substrate. For example, one or more glass substrates may be cleaned by immersing the substrate in NaOH (2.5 M) solution for 24 hours, sonicating the glass substrate in water for 10 minutes, immersing the substrate in HCl (0.1 M) for 15 minutes, sonicating the substrate again in water for 10 minutes, and immersing the substrate in methanol for 5 minutes. Next, the method 200 may comprise step 204 of dipping the substrate in an aqueous silane solution (e.g., 1% aqueous solution of silane) for about 5-30 minutes, shaking the substrate in methanol for about 5 minutes (step 206), rinsing it in water for about 10 minutes (step 208), centrifuging the substrate to dry (e.g., at 2000 rpm) for about 5 minutes (step 210), and baking the substrate at about 110° C. for about 15 minutes (step 212). The silanized substrates may optionally be stored in a vacuum desiccator (step 214). Additional methods of silanization using immersion are described elsewhere, such as in “Surface characterizations of mono-, di-, and tri-aminosilane treated glass substrates.” by Metwalli, E, Haines, D, Becker, O, Conzone, S and Pantano, C G (2006). Journal of Colloid and Interface Science 298: 825-831, which is hereby incorporated by reference in its entirety.

Tissue adhesive substrates comprising an amino silane covalently bound to a glass substrate may be capable of retaining a tissue section, such as an ultrathin tissue section (e.g., from about 50 nm to about 200 nm), through multiple cycles of antibody staining and stripping without discernible or substantial damage to the tissue section. A tissue adhesive substrate that is capable of adhering a tissue section under such conditions may be desirable for array tomography, where tissue sections may be subject to repeated cycles of antibody staining and stripping. One cycle of antibody staining and stripping may comprise applying a set of one or more fluorescent dye-labeled antibodies to a tissue section adhered to a substrate, imaging the tissue section, and then treating the adhered tissue section in an elution solution for about 20 minutes. In some embodiments, applying a set of one or more fluorescent dye-labeled antibodies to an adhered tissue section may comprise incubating the adhered tissue section with a primary antibody for about 1 to about 12 hours, and incubating the adhered tissue section with a fluorescently-labeled secondary antibody for about 30 minutes to about an hour. In some variations, an elution solution may comprise 0.2M NaOH/0.02% SDS. In some variations, the adhered tissue section may be treated in an elution solution for about 5 minutes to about 40 minutes (e.g., 5 minutes, 10 minutes, 20 minutes, 30 minutes, etc.). The ability of a tissue adhesive substrate to retain and maintain a tissue section may be evaluated by treating the adhered tissue section in an elution for multiple 20-minute elution cycles, where one elution cycle may comprise incubating the adhered tissue section in an elution solution approximately for 20 minutes without incubating the adhered tissue section in a fluorescent dye-labeled antibody solution. Tissue adhesive substrates comprising an amino silane covalently bound to a glass substrate using vapor deposition may be capable of retaining a tissue section, such as an ultrathin tissue section, through at least five cycles of 20-minute elution solution treatments without discernible or substantial damage to the tissue section. Such amino silanized tissue adhesive substrates may be capable of retaining a tissue section through at least five cycles of antibody staining and stripping without discernible or substantial damage to the tissue section. For example, tissue adhesive substrates comprising 3-aminopropyltrimethoxysilane deposited on a glass substrate or coverslip by vapor deposition may be capable of retaining a tissue section through at least 5 elution cycles without discernible damage to the tissue section and/or substrate. The ability of an amino silanized tissue adhesive substrates to retain a tissue section through multiple cycles without discernible or substantial damage is further characterized and described below.

Damage to a tissue section that is adhered to a substrate may be characterized by the degree to which the tissue section has buckled, folded, peeled away, dissociated, and/or lifted away from the substrate. For example, damage to a tissue section may be characterized by the percent of the tissue that has buckled, folded, peeled away, dissociated, and/or lifted away from the substrate. Damage to an adhered tissue section may also be characterized by the amount of cracking observed in the tissue section, such as the number, size, depth, and density of cracks and/or folds in the tissue section. In some aspects, an adhered tissue section may be considered damaged if the tissue surface is discontinuous and/or non-planar. More generally, damage to the tissue section may be any physical distortion of the tissue that impedes the three-dimensional reconstruction of volumetric data from acquired two-dimensional images. In some variations, “discernible damage” may be considered any of the damage described above that can be visually observed with the naked eye. Alternatively or additionally, “discernible damage” may be any of the damage described above that is visible under 4× magnification (e.g., under phase contrast microscopy). “Discernible damage” may be any degree of damage described above and/or discontinuity in the tissue section that may cause misalignment and/or distortion and/or resolution loss during the stitching of two-dimensional image data into a three-dimensional data set (e.g., to generate volumetric data). For example, “discernible damage” may result in the loss of final structural details of the tissue section or sample. In some variations, “discernible damage” may result in image distortions that may be recovered or reconstructed by image processing algorithms or methods. “Substantial damage” may be considered any damage that would result in a volumetric gap during the reconstruction of an array tomographic image that would render it impossible to resolve certain parts of the tissue section or sample. For example, an adhered tissue section may be considered as having “substantial damage” if there are one or more cracks and/or folds that separate a single tissue section into multiple smaller sections, and/or if there is heavy cracking or creasing that result in image distortions that cannot be recovered or compensated for by image processing algorithms or methods.

One variation of a tissue adhesive substrate may comprise a glass substrate, a silane covalently bound to the glass substrate, and a carbon coating. The silane may be deposited on the glass substrate by vapor deposition (e.g., using the method 200 described above), after which the silane may be coated with carbon. In some variations, the silane may comprise a functional group that has an affinity for amorphous carbon. A carbon-coated silanized glass substrate may be capable of retaining a tissue section, such as an ultrathin tissue section, through at least 12 elution cycles (e.g., where one elution cycle may comprise incubating the adhered tissue section in an elution solution for 20 minutes). In some variations, the tissue adhesive substrate may be capable of retaining a tissue section through at least 105 cycles of 20-minute elution cycles. In some variations, a carbon-coated silanized glass substrate may be capable of retaining a tissue section, such as an ultrathin tissue section, through at least 105 cycles of antibody staining and stripping (e.g., where one cycle of antibody staining and stripping may comprise applying a set of one or more fluorescent dye-labeled antibodies to a tissue section adhered to a substrate, imaging the tissue section, and treating the adhered tissue section in an elution solution for approximately 20 minutes) without substantial damage to the tissue section. In some embodiments, applying a set of one or more fluorescent dye-labeled antibodies to an adhered tissue section may comprise incubating the adhered tissue section with a primary antibody for about 1 to about 12 hours, and incubating the adhered tissue section with a fluorescently-labeled secondary antibody for about 30 minutes to about an hour. The silane may be an amino silane, and in some variations, may comprise an aryl or an alkyl moiety. It is understood that any silane provided herein, including amino silanes, may be carbon-coated and that tissue adhesive substrates comprising carbon-coated silanes are described.

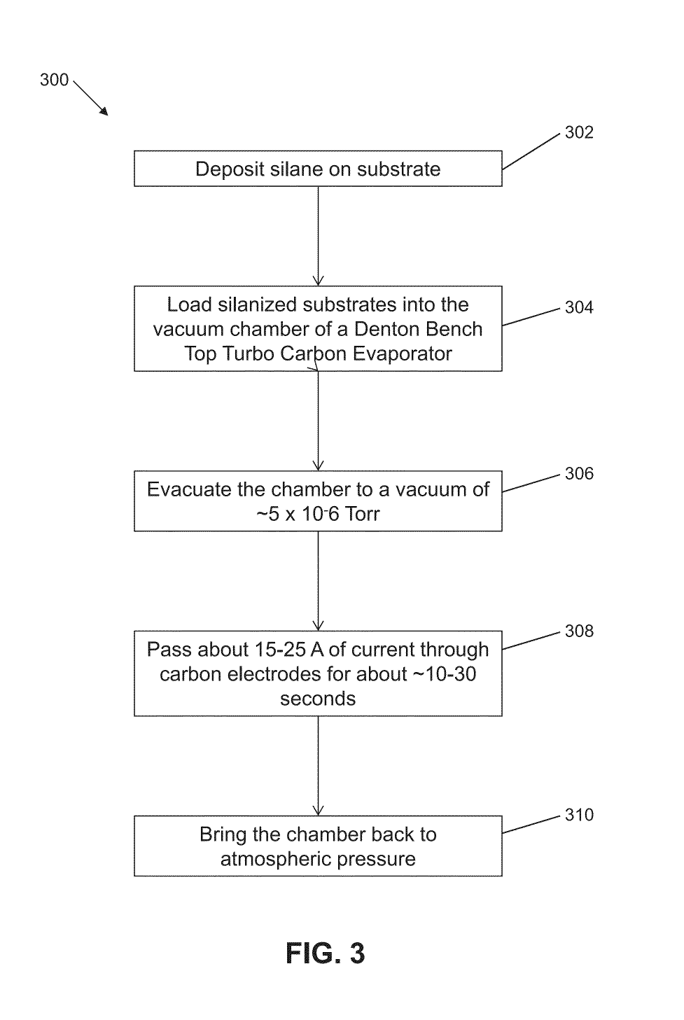

A tissue adhesive substrate comprising a glass substrate, a silane covalently bound to the glass substrate, and a carbon coating may be made using any suitable method. In some variations, a carbon-coated silanized tissue adhesive substrate may be made by silanizing a substrate using any of the methods described above, and using a coating system (e.g., a vacuum coating system and/or sputter coater system) to deposit carbon on the silanized tissue substrate. FIG. 3 depicts one example of a method 300 for making a tissue adhesive substrate comprising a silane (e.g., any of the silanes described above) and a carbon coating. The method 300 may comprise step 302 of covalently binding the silane to a glass substrate by vapor deposition (e.g., as described above and depicted in FIG. 1) or immersion (e.g., as described above and depicted in FIG. 2). The method 300 may further comprise loading the silanized substrates into a coating system (step 304), such as a vacuum system (e.g., the vacuum chamber of a Denton Bench Top Turbo Carbon Evaporator), evacuating the chamber to a vacuum of ˜5×10⁻⁶ Torr (step 306), passing about 15-25A of current through carbon electrodes for about 10-30 seconds (step 308), and bringing the chamber back to atmospheric pressure (step 310). Without being bound by theory, the carbon coating may be covalently bound to the silane or may be associated with the silane by van der Waals forces.

Tissue adhesive substrates comprising a silane covalently bound to a glass substrate and coated with carbon may be capable of retaining a tissue section, such as an ultrathin tissue section (e.g., from about 50 nm to about 200 nm), through multiple cycles of antibody staining and stripping without discernible or substantial damage to the tissue section. For example, a carbon-coated silanized substrate may be capable of retaining a tissue section, such as an ultrathin tissue section, through at least 5 cycles, 12 cycles, 50 cycles, 100 cycles, 105 cycles of antibody staining and stripping and/or elution cycles without discernible or substantial damage to the tissue section.

The carbon coating on a tissue adhesive substrate may provide a nm-thick fiducial layer and/or may act as a fiduciary marker that may help to provide sufficient contrast at the interface between the substrate and the tissue section for the operation of reflection autofocus (e.g., such as may be employed in a commercially available autofocus system). For example, the carbon-coating may provide a robust reflection signal back to the autofocus system to allow the system to readily identify the region of interest. In some variations, an autofocus system may readily identify the focal plane of the carbon coating of a tissue adhesive substrate, which may allow the system to readily identify the focal plane of a tissue section adhered to the carbon-coated substrate. The carbon coating may also provide sufficient reflective properties while providing stable attachment of the tissue section to the substrate. For example, the carbon coating component of a tissue adhesive substrate may have a refractive index that is different from the refractive index of the adhered tissue section, such that the carbon coating may reflect visible light and/or near-infrared (NIR) light differently from an adhered tissue section. Using a NIR source may help to ensure that the autofocus neither interferes with the fluorescence detection nor induces bleaching of the sample fluorescence. Carbon-coated tissue adhesive substrates may provide sufficient reflective properties for commercially available image-based autofocus systems (including LED- or laser-based autofocus systems), as well as allow multi-channel imaging of the tissue section without bleaching the fluorescence of the tissue section.

A tissue adhesive substrate comprising a silane covalently bound to a glass substrate and coated with carbon may be capable of retaining a tissue section through the process of electron microscopy (EM) imaging without substantial damage to the tissue section. For example, a carbon-coated silanized tissue adhesive substrate may allow for EM imaging of a tissue section at higher beam energies with less accompanying tissue degradation as compared to imaging of a tissue section adhered to a carbon-coated subbed tissue adhesive substrate. In some variations, there may be no degradation and/or damage during EM imaging to a tissue section mounted on carbon-coated silanized substrates. This may improve the quality of EM images as compared to carbon-coated subbed slides, particularly at higher beam energies. While SEM imaging is described herein, it should be understood that any desired type of EM imaging may be used, including, reflection electron microscopy (REM).

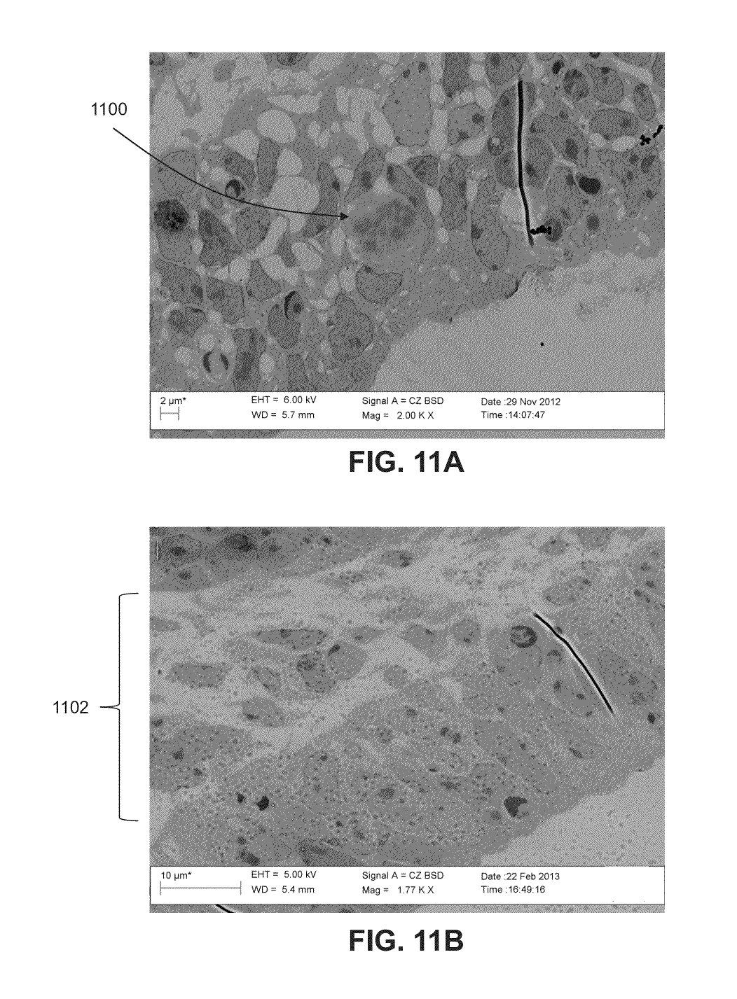

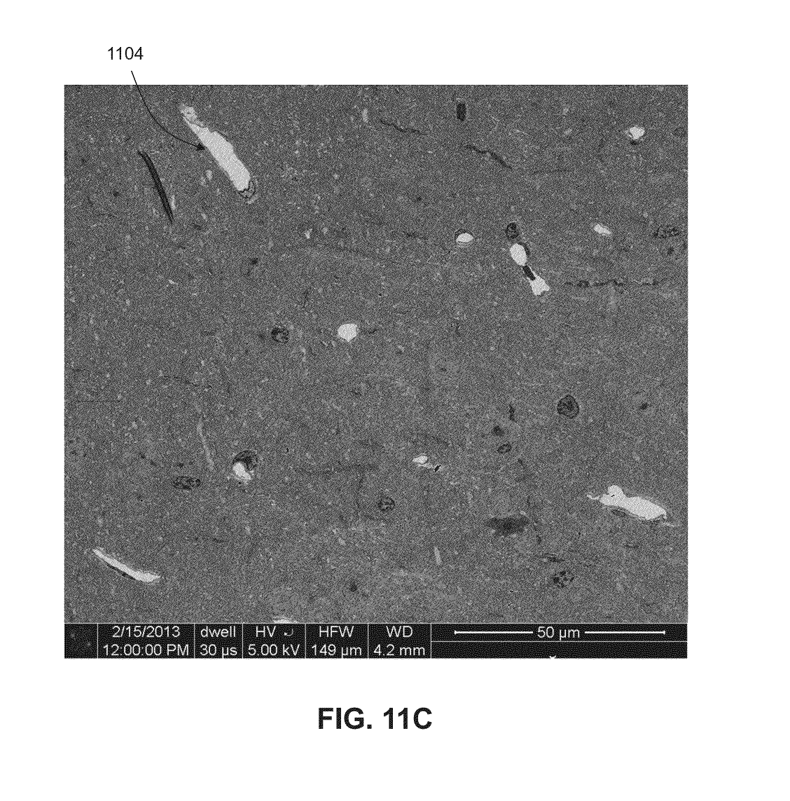

Without being bound by theory, a tissue section adhered to a carbon-coated subbed slide may be prone to absorption of energy and/or charging from the electron beam in the subbed layer. This may cause the subbed layer to be heated to the point where the tissue section may begin to degrade and/or be damaged, which may distort the acquired electron micrographs. Examples of tissue sections adhered to carbon-coated subbed slides that have been damaged during SEM imaging are depicted in FIGS. 11A and 11B. As shown there, SEM imaging has resulted in tissue damage that results in bubble-like image distortions (e.g., melted region 1100 in FIG. 11A and gelatin-reactive regions 1102 in FIG. 11B) that obscure structural features. A tissue section adhered to a carbon-coated silanized slide may be less susceptible to such heating, which may reduce or eliminate the incidence of tissue damage and/or image distortion. Since the tissue section is not subjected to as much heat (e.g., due to charging and/or energy deposition from the electron beam), higher quality images of the tissue sections may be obtained. An example of an EM image of a tissue section adhered to a carbon-coated silanized slide is depicted in FIG. 11C (the clear regions, such as region 1104, are blood vessels). EM imaging after immunostaining and fluorescence imaging of a tissue section may be desirable for forming three-dimensional composite images. Methods of immunostaining and fluorescence imaging that may optionally be followed with EM imaging are described below.

The tissue adhesive substrates described herein may be used for various immunohistochemical analyses, including array tomography. A method for performing array tomography may comprise fixing the tissue sample, dissecting the sample and embedding the sample in resin, cutting the resin-embedded sample using a ultramicrotome to produce a ribbon of tissue, transferring the ribbon to the surface of a tissue adhesive substrate (e.g., any of the tissue adhesive substrates described above), incubating the tissue sections with one or more fluorescent dye-labeled antibodies or other reagents, imaging the tissue sections with a fluorescence microscope, and stitching the individual two-dimensional data into volumetric data. Optionally, the staining of additional fluorescent dye-labeled antibodies may be analyzed by stripping the previously applied fluorescent dye-labeled antibodies from the tissue sections using an elution solution (e.g., any of the elution solutions described above), contacting the tissue sections with additional fluorescent dye-labeled antibodies and re-imaging the tissue sections. These steps may be repeated as desired. In some variations, the tissue sections may be treated in an elution solution for about 5 minutes to about 40 minutes (e.g., 5 minutes, 10 minutes, 20 minutes, 30 minutes, etc.). Other immunohistochemical analyses using the tissue adhesive substrates described herein may employ a one or more of the steps described above. Optionally, EM imaging of each tissue section may be performed after immunostaining and fluorescence imaging.

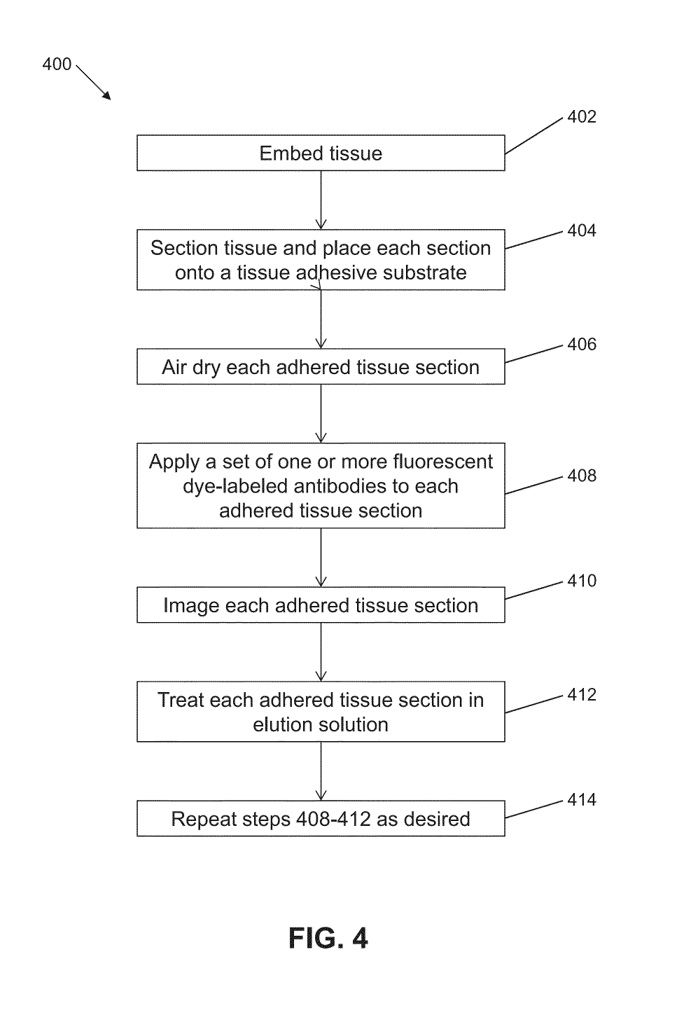

One example of a method 400 of using the tissue adhesive substrates described herein for an immunohistochemical analysis (such as array tomography) is depicted in FIG. 4. The method 400 may comprise embedding the tissue (step 402), for example, in LRWhite resin. The tissue could be any tissue of interest, for example, neural tissue or skin tissue (e.g., of a human, mouse, rat, rabbit, guinea pig, tiger salamander, C. elegans, etc.). An ultramicrotome may then be used to cut a ribbon of about 20 to about 60 tissue sections (e.g., ultrathin sections), which may then be placed onto one or more tissue adhesive substrates, such as coated glass slides, coverslips, amino silanized glass substrates, or carbon-coated silanized glass substrates as described above (step 404). In some aspects, a ribbon may comprise about 5 to about 100 tissue sections. The adhered tissue sections may then be air-dried and placed on a 60° C. slide warmer for 30 minutes (step 406). The adhered tissue sections may optionally be stored at room temperature. Additional description regarding tissue embedding may be found in various publications, including “Array tomography: rodent brain fixation and embedding.” by Micheva, K D, O'Rourke, N, Busse, B, Smith, S J, (2010). Cold Spring Harb Protoc doi:10.1101/pdb.prot5523, which is hereby incorporated by reference in its entirety. The method 400 may further comprise applying a first set of one or more fluorescent dye-labeled antibodies to the one or more adhered tissue sections (step 408), imaging the one or more adhered tissue sections (410), and then treating the one or more adhered tissue sections in an elution solution, for example, an elution solution comprising 0.2M NaOH/0.02% SDS (step 412). Applying a set of one or more fluorescent dye-labeled antibodies may comprise contacting the one or more adhered tissue sections in a solution that contains 1, 2, 3, 4 or more fluorescent dye-labeled antibodies. The one or more adhered tissue sections may be imaged using an optical imaging system, such as a fluorescence microscope, optionally including an autofocus system (e.g., any of the autofocus systems described above), and the like. The optical imaging system may have one or more fluorescent imaging channels (e.g., 1, 2, 3, 4, or more channels) that may be used to image the adhered tissue sections to evaluate the staining and/or staining of each of the fluorescent dye-labeled antibodies to the tissue section. In some variations, tissue sections adhered to carbon-coated silanized glass substrates may be imaged using electron microscopy. The elution step 412 may comprise contacting the adhered tissue sections in an elution solution for approximately 20 minutes. In some variations, the adhered tissue sections may be treated in an elution solution for about 5 minutes to about 40 minutes (e.g., 5 minutes, 10 minutes, 20 minutes, 30 minutes, etc.). After the elution step 412, steps 408 to 412 may be iterated as many times as desired (step 414), where an additional set of one or more fluorescent dye-labeled antibodies that may be different from the first set is applied to the adhered tissue sample. The images of the adhered tissue samples obtained using the method 400 may be stored in any suitable computer-readable medium, and may be processed for volumetric reconstruction. Optionally, the images obtained in each iteration of steps 408-412 may be examined and evaluated to determine the quality and integrity of the tissue section prior to conducting an additional iteration.

Any of the methods of using the tissue adhesive substrates described herein may include both fluorescence imaging and EM imaging for a composite immunohistochemical analysis of a tissue sample. For example, a method of providing both fluorescence and scanning electron images of a tissue section (e.g., such as a tissue section for array tomography) may comprise obtaining a fluorescence image of the immunostained tissue section (e.g., per the methods described and depicted in FIG. 4 above and elsewhere), and contacting the tissue section with an electron microscopy contrast agent. Examples of electron microscopy contrast agents may include one or more heavy metals (e.g., gold particles, colloidal gold particles, uranium, lead, platinum, and/or osmium) and/or antibodies bound to one or more types of heavy metals (e.g., gold particles, colloidal gold particles, uranium, lead, platinum, and/or osmium). For example, immunogold labels that may be used to contact the tissue section include may include different antibodies bound to gold particles of different sizes to image different molecules of interest. Optionally, the method may comprise contacting the tissue section with heavy metals. Heavy metals that may be used to stain additional features of interest and/or provide contrast between different structures in the tissue section may include uranium, lead, platinum, and/or osmium. The EM images of a plurality of tissue sections of a tissue sample can be aligned with the corresponding multichannel fluorescence images the same tissue sections and assembled into a composite three-dimensional representation of the tissue sample.

Alternatively, some methods of using the tissue adhesive substrates described herein may include EM imaging without fluorescence imaging. For example, after embedding a tissue, sectioning the tissue, placing each section onto any of the tissue adhesive substrates described above (e.g., a carbon-coated silanized substrate), and air drying each adhered tissue section as described previously, each tissue section may be contacted with an electron microscopy contrast agent (e.g., any of the contrast agents described above). The tissue section may then be imaged using an electron microscope.

A kit for immunohistochemical analysis may comprise a tissue adhesive substrate and instructions for using the tissue adhesive substrate (e.g., instructions for use in any of the methods detailed herein). In one variation, a kit may comprise one or more tissue adhesive substrates having a glass substrate and a silane covalently bound to the glass substrate, and instructions for using the tissue adhesive substrates (e.g., instructions for use in any of the methods detailed herein). The tissue adhesive substrates may be capable of retaining a tissue section, such as an ultrathin tissue section, through at least 5 cycles of antibody staining and stripping. The tissue adhesive substrates may be amino silanized tissue adhesive substrates, or any of the silanized substrates described above. In another variation, a kit may comprise one or more tissue adhesive substrates having a glass substrate, a silane covalently bound to the glass substrate, and a carbon coating. The kit may also comprise instructions for using the carbon-coated silanized tissue adhesive substrates (e.g., instructions for use in any of the methods detailed herein). The carbon-coated silanized tissue adhesive substrates may be capable of retaining a tissue section, such as an ultrathin tissue section, through at least 5 cycles of antibody staining and stripping, and may be any of the carbon-coated silanized substrates described above. Optionally, any of the kits described above may additionally comprise adhered embedded tissue and one or more primary and/or secondary antibodies and/or fluorescent dye-labeled antibodies and/or electron microscopy contrast agents (e.g., uranium, lead and/or gold-labeled antibodies).

### EXAMPLES

Described below are examples of various tissue adhesive substrates and methods of making such tissue adhesive substrates. These examples illustrate the characteristics of silanized tissue adhesive substrates and carbon-coated tissue adhesive substrates that have been subjected to multiple cycles of elution solution treatment.

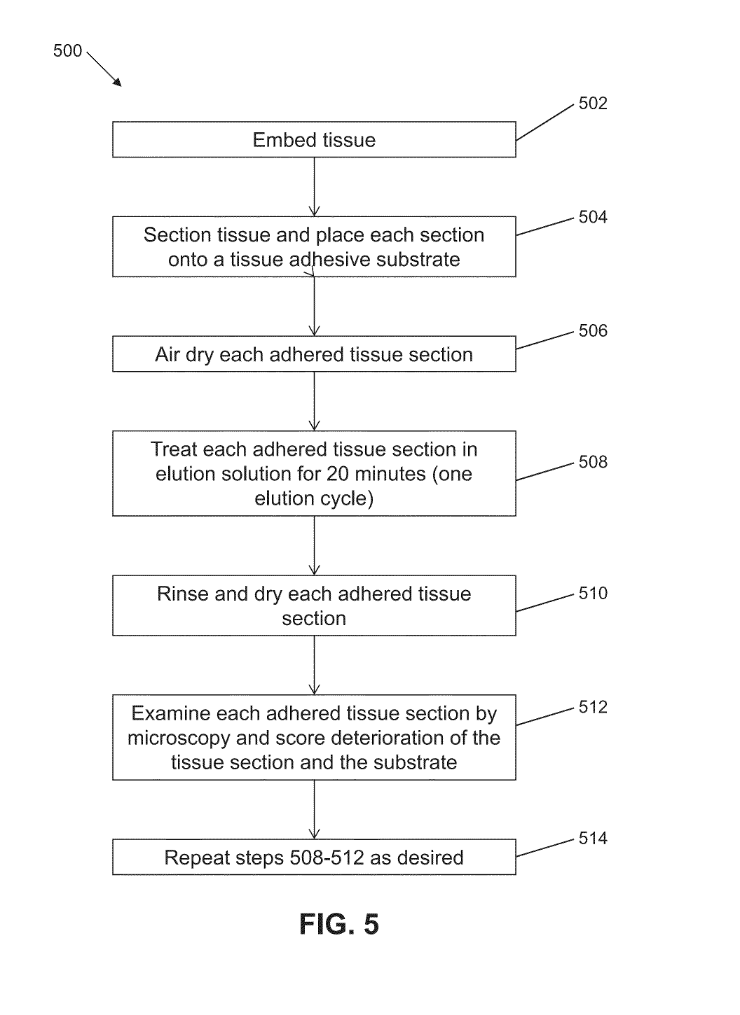

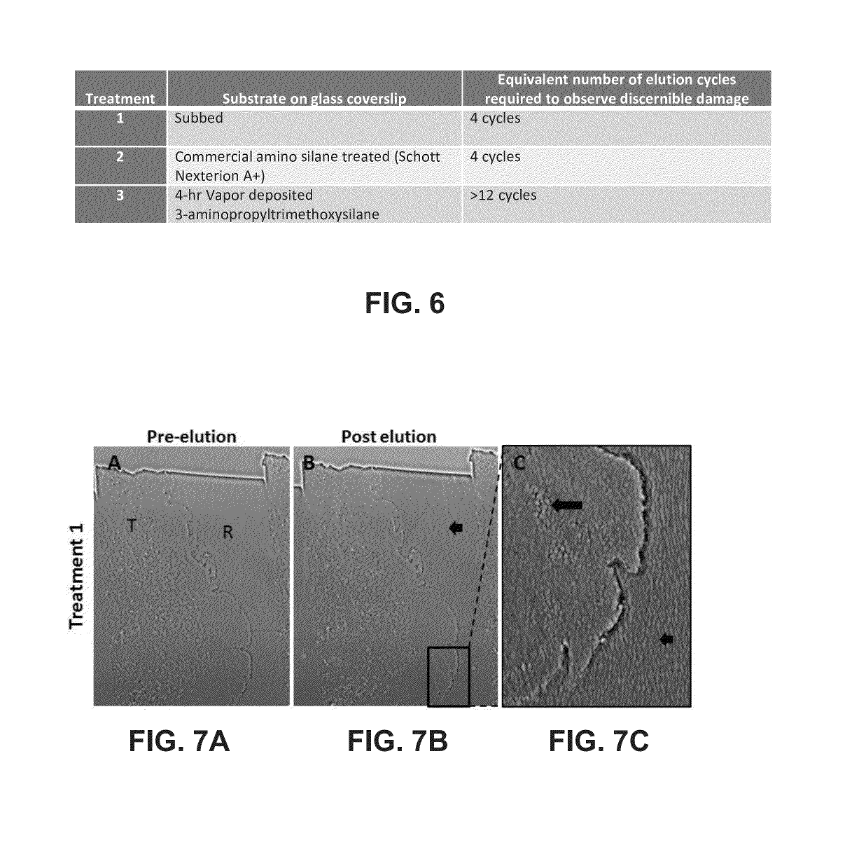

In order to assess adherence of embedded tissue sections (e.g., ultrathin resin-embedded tissue sections) to the substrate through multiple cycles of antibody staining and subsequent elution, the test protocol 500 depicted in FIG. 5 was used. First, tissue (either human skin or mouse brain) was embedded in LRWhite resin (step 502). Next, an ultramicrotome was used to cut a ribbon of 20 to 60 tissue sections (e.g., ultrathin tissue sections), and each section was placed onto a coated glass slide or coverslip (step 504). In some experiments, the coated glass slide was an amino silanized glass substrate, while in other experiments the coated slide was a carbon-coated silanized glass substrate. In still other experiments, the coated glass slide was a glass substrate coated with gelatin and/or various functional groups, as indicated in the Tables (FIGS. 6, 8 and 10). The adhered tissue sections were then air dried and placed on a 60° C. slide warmer for 30 minutes and stored at room temperature (step 506). The tissue samples were embedded based on the methods described in the following publication: Micheva, K D, O'Rourke, N, Busse, B, Smith, S J, (2010). Array tomography: rodent brain fixation and embedding. Cold Spring Harb Protoc doi:10.1101/pdb.prot5523, which was previously incorporated by reference in its entirety. The tissue samples were sectioned based on the methods described in the following publication: Micheva, K D, O'Rourke, N, Busse, B, Smith, S J, (2010). Array tomography: production of arrays. Cold Spring Harb Protoc doi:10.1101/pdb.prot5524, which was previously incorporated by reference in its entirety.

Next, the adhered tissue sections were subjected to an “elution cycle”, where in each elution cycle, the tissue sections were treated with an elution solution (0.2M NaOH/0.02% SDS) for approximately 20 minutes (step 508). After the adhered tissue section was treated in the elution solution for approximately 20 minutes, it was then rinsed twice in tris-buffered saline (TBS) for 10 minutes each time, then rinsed in water, air dried, and placed on a 60° C. slide warmer for 30 minutes (step 510). The adhered tissue sections were examined by phase-contrast microscopy and scored for cracking, peeling and other deterioration of the tissue sections, resin areas and substrate (step 512). In some experiments, the adhered tissue sections were then subjected to additional elution cycles, where between each elution cycle, the tissue sections were rinsed with TBS, dried, imaged, and scored for deterioration (step 514). Additional details about the elution cycles described herein may be found in the following publication: Micheva, K D, O'Rourke, N, Busse, B, Smith, S J, (2010). Array tomography: Immunostaining and antibody elution. Cold Spring Harb Protoc doi:10.1101/pdb.prot5525, which is hereby incorporated by reference in its entirety. In some cases, longer incubation periods in elution solution were used to emulate multiple elution cycles.

### Example 1

Embedded tissue sections were adhered to subbed coverslips that were prepared according to Micheva, K D, O'Rourke, N, Busse, B, Smith, S J, (2010). Array tomography: Production of arrays. Cold Spring Harb Protoc doi:10.1101/pdb.prot5524 (Treatment 1). Embedded tissue sections were also adhered to commercially-available silanized Schott Nexterion A+ glass substrates (Treatment 2). Embedded tissue sections were also adhered to glass coverslips treated with aminopropyltrimethoxysilane, which was deposited by vapor deposition for 4 hours (Treatment 3).

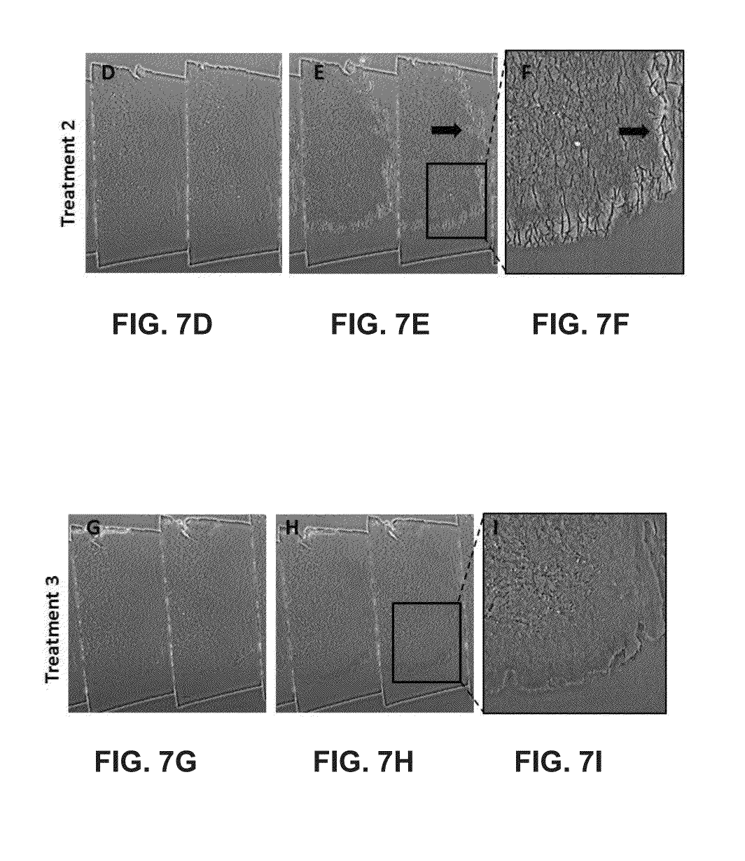

Tissue sections adhered to Treatment 1 substrates and Treatment 2 substrates began to show damage after 4 elution cycles (80 minutes total in elution solution). Tissue sections adhered to Treatment 3 substrates repeatedly showed no damage after 12 elution cycles (240 minutes total in elution buffer). These results are shown in FIG. 6. FIGS. 7A to 7I depict phase-contrast micrographs of tissue sections on different substrates after repeated elution cycles. FIGS. 7A, 7D, 7G depict phase-contrast micrographs of tissue sections prior to any elution cycles. FIG. 7B (Treatment 1 substrates) and FIG. 7E (Treatment 2 substrates) depict phase-contrast micrographs of tissue sections after 4 elution cycles. FIG. 7H (Treatment 3 substrates) depicts phase-contrast micrographs of tissue sections after 12 elution cycles. Enlargements of a portion of FIGS. 7B, 7E, and 7H are shown in FIGS. 7C, 7F, and 7I, respectively. Each micrograph shows one or two adjacent tissue sections, each containing areas with tissue (T), or resin (R) only (see labels in FIG. 7A). Damage is apparent as cracking in both tissue areas (long arrows in FIGS. 7B, 7E, 7F) and in resin-only areas (short arrow, FIG. 7C). Treatment 3 showed no discernible damage after 12 elution cycles (FIGS. 7H and 7I). The elution procedure reproducibly causes cracking and creasing in both tissue and resin-only regions of the sections on Treatment 1 and Treatment 2 substrates (FIGS. 7A to 7C and 7D to 7F), while tissue and resin-only regions on Treatment 3 substrates remained completely undamaged (FIGS. 7G to 7I). Treatment 3 therefore significantly outperformed previously described and commercially silanized surfaces for the retention of intact tissue sections for array tomography.

### Example 2

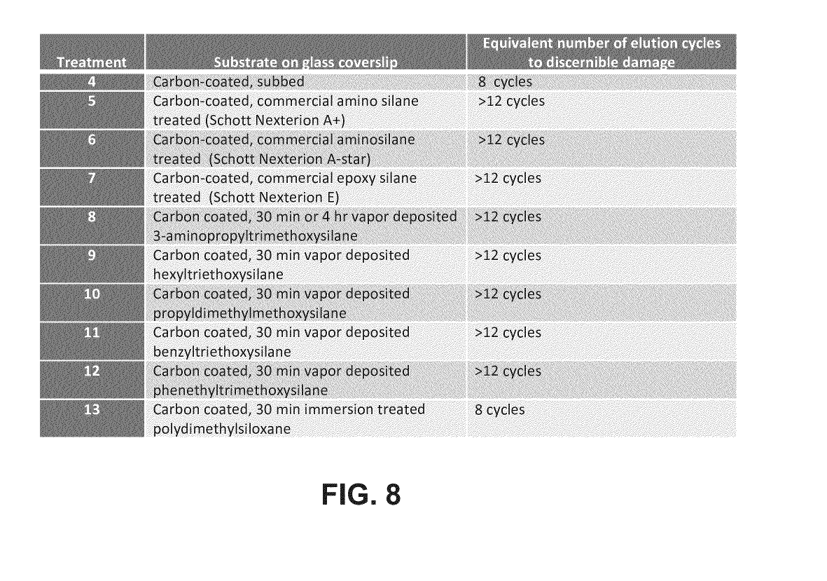

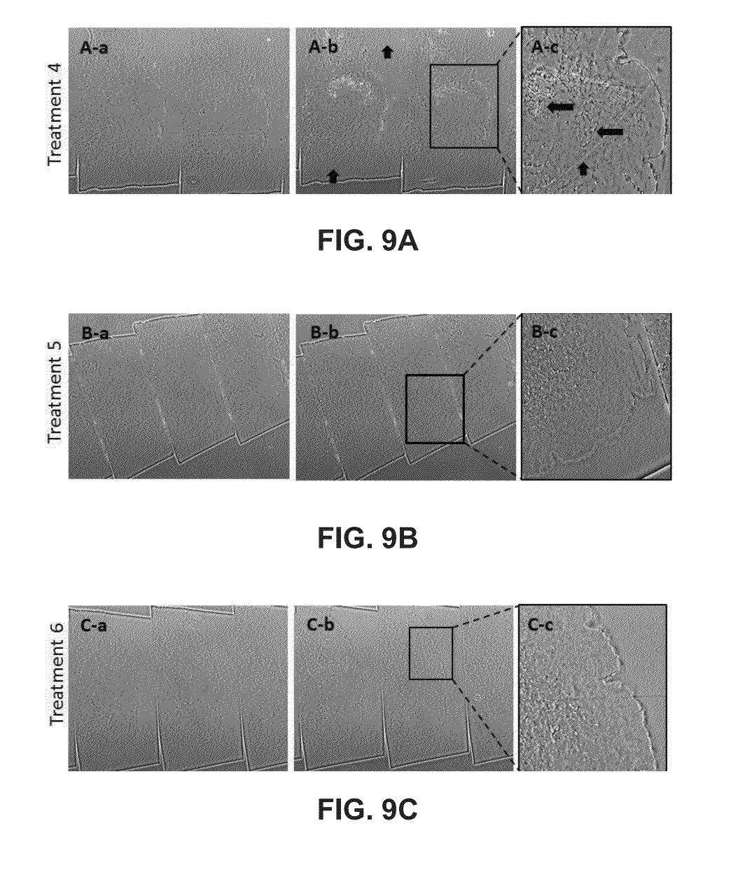

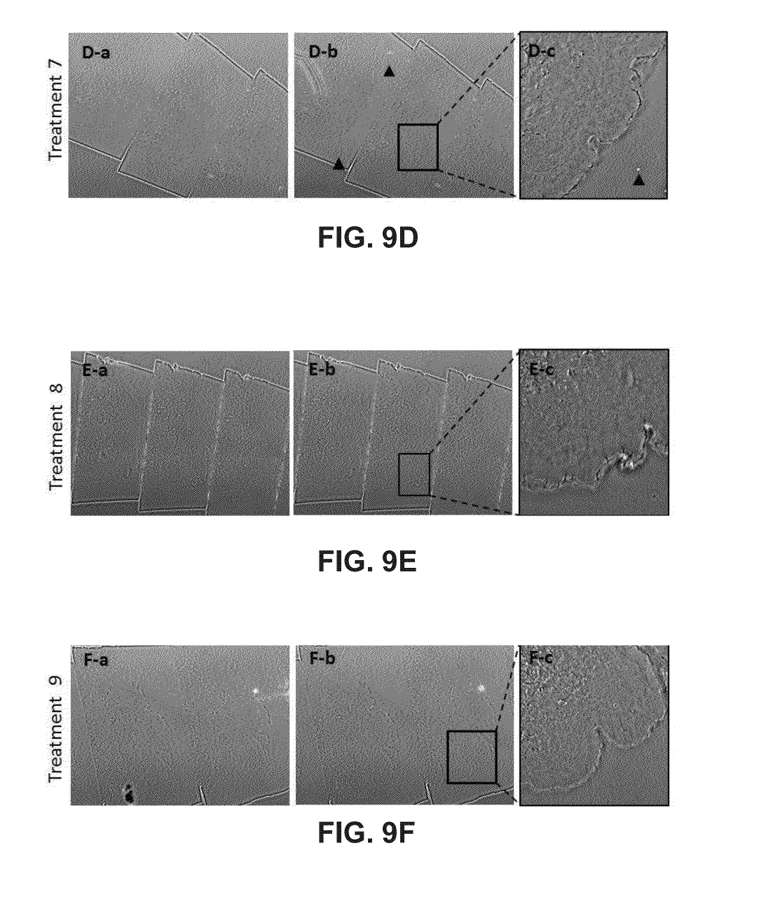

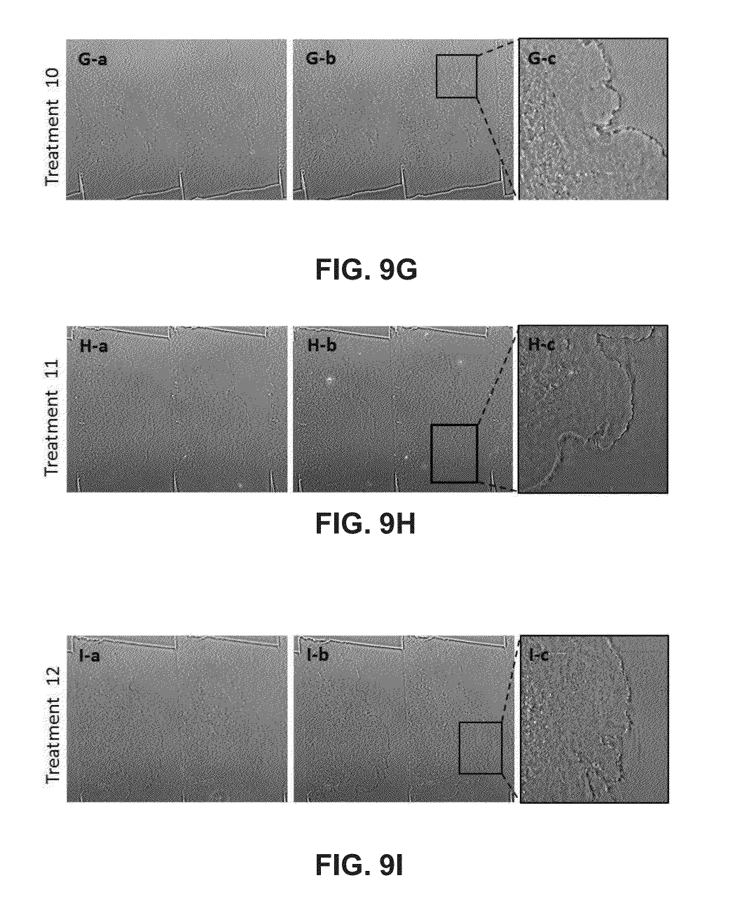

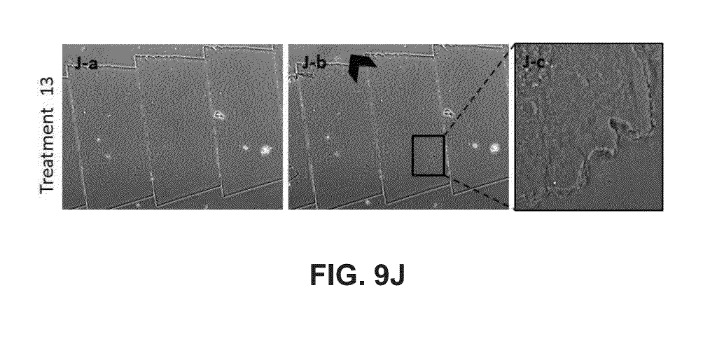

We compared tissue section retention on carbon-coated silanized coverslips to carbon-coated subbed and carbon-coated commercially silanized glass. Embedded tissue sections were adhered to the various carbon-coated substrates and treated with various numbers of elution cycles, as tabulated in FIG. 8. Phase-contrast micrographs for tissue sections adhered to these substrates after repeated elution cycles are depicted in FIGS. 9A to 9J. Phase-contrast micrographs of tissue sections on surface treatments 4 through 13 before repeated elution cycles are depicted in Panel-a of FIGS. 9A to 9J, and micrographs of the tissue sections after repeated elution cycles are depicted in Panel-b of FIGS. 9A to 9J. Enlargements of a region annotated in Panels-b are shown in Panels-c for each treatment. Tissue sections adhered to carbon-coated subbed substrates (Treatment 4) began to show damage after 8 elution cycles (160 minutes total in elution solution), while tissue sections mounted on carbon-coated commercially available glass coverslips treated with three silanes (Treatments 5, 6, and 7) showed no damage through 12 elution cycles (240 minutes in elution buffer). Carbon-coated coverslips coated with five different silanes by vapor deposition (Treatment 8: 3-aminopropyltrimethoxysilane, 30 minute or 4 hour vapor deposition; Treatment 9: hexyltriethoxysilane, 30 minute vapor deposition; Treatment 10: propyldimethylmethoxysilane, 30 minute vapor deposition; Treatment 11: benzyltriethoxysilane, 30 minute vapor deposition; Treatment 12: phenethyltrimethoxysilane, 30 minute vapor deposition) also showed no damage through 12 elution cycles (240 minutes in elution buffer). Tissue sections on carbon-coated coverslips coated by immersion in polydimethylsiloxane (Treatment 13) were resistant to damage though 8 elution rounds (160 minutes total in elution solution). Panels-b and Panels-c show the tissue sections after 8 elution cycles (Treatment 4, FIG. 9A), 12 elution cycles (Treatments 5, 8, 9, 10, 12, and 13, FIGS. 9B, 9E to 9G, 9I and 9J, respectively), 13 elution cycles (Treatment 7, FIG. 9D), 14 elution cycles (Treatment 11, FIG. 9H), and 17 elution cycles (Treatment 6, FIG. 9C). Micrographs show two or three adjacent tissue sections. Damage is apparent as cracking in the carbon coating (vertical arrows, FIGS. 9A-b and 9A-c), tissue cracking (horizontal arrows, FIGS. 9A-c), pinholes in the resin-only regions (triangles, FIGS. 9D-b and FIGS. 9D-c), or peeling and lifting of the carbon layer (chevron, FIGS. 9J-b). Carbon coating tissue adhesive substrates improved the adhesion of tissue sections, as tabulated in FIG. 8. Silanized substrates (e.g., carbon-coated silanized substrates) were an improvement over subbed substrates (e.g., carbon-coated subbed substrates).

### Example 3

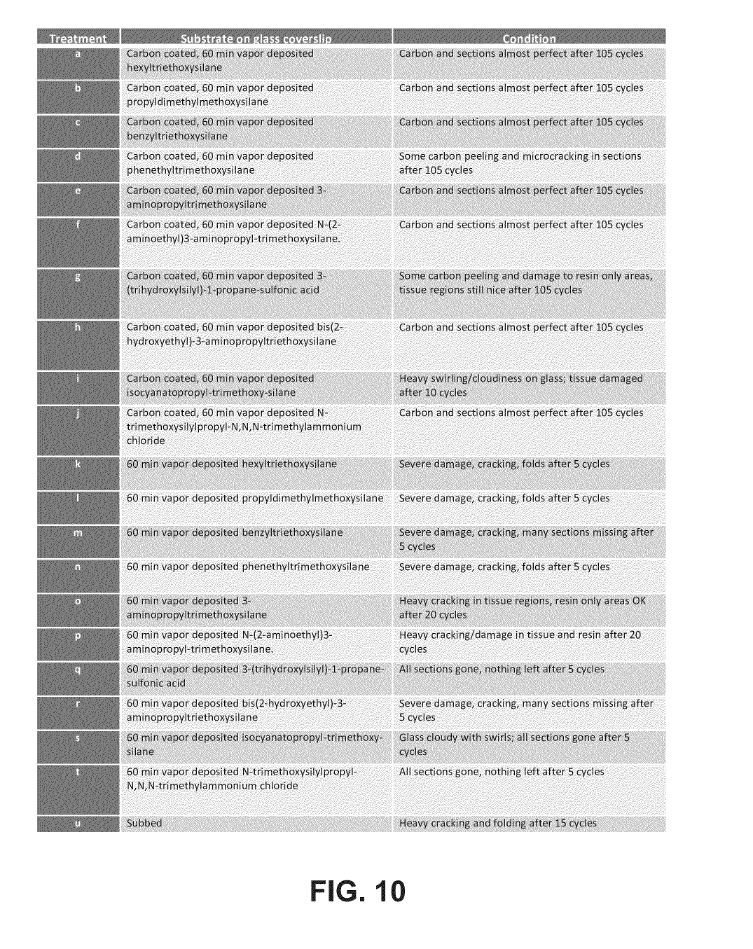

An expanded set of silanes were tested in an additional experiment. The table depicted in FIG. 10 lists the different tissue adhesive substrates to which embedded tissue sections were mounted, and the condition of the tissue section and/or substrate after repeated elution cycles.

A variety of silanes, having hydroxyl-methoxy- or ethoxy-reactive groups and a variety of terminal groups, including charged, polar, aryl and alkyl moieties, when deposited with the vapor procedure described above onto substrates that have been cleaned per the protocol, act to adhere a vapor-deposited carbon layer to a glass or silica substrate. This may work to allow embedded tissue to be stably adhered to the substrate against the equivalent of >100 cycles of antibody elution.

Adhesion of embedded tissue directly to a silanized surface through multiple (e.g., about 20) rounds of the elution procedure was observed only for amino-terminated compounds. Strikingly, the substrate prepared per the vapor deposition protocol described above to generate a 3-aminopropyl-silyl substrate surface was superior to the commercially available substrate.

### Example 4

FIGS. 11A and 11B depict SEM images of tissue sections adhered to carbon-coated subbed slides and FIG. 11C depicts a SEM image of a tissue section adhered to a carbon-coated silanized slides. The sections for FIGS. 11A-11C were stained with 5% uranyl acetate in double distilled H₂O by immersing the sections for 30 minutes. The uranyl acetate solution was filtered (0.22 μm filter) immediately before application. The sections were washed by slowly pouring ≈50 mL doubly distilled H₂O over the sections.

Next, the sections were immersed in a fresh lead citrate solution (filtered with 0.22 μm) for 1 minute, and the excess was washed off with 50 mL ddH₂O. To prevent the lead citrate from reacting with CO₂, which would cause an electron dense precipitate to form, NaOH pellets were placed immediately adjacent to the tissue sections and both the sections and pellets were covered with top half of a glass petri dish, which creates a temporary CO₂-free zone. The sections were removed from the CO₂-free zone just prior to SEM imaging.

References to “about” a value or parameter includes and describes embodiments that are directed to that value or parameter per se. For example, a reference to “about X” includes and describes X per se.

What is claimed is:

1: A tissue adhesive substrate comprising:
a glass substrate;
a silane covalently bound to the glass substrate; and
a carbon coating.

2: The tissue adhesive substrate of claim 1 wherein the silane is deposited on the glass substrate by vapor deposition.

3: The tissue adhesive substrate of claim 1, wherein the tissue adhesive substrate is capable of retaining an ultrathin tissue section through at least 12 cycles of antibody staining and stripping without discernible damage to the tissue section.

4: The tissue adhesive substrate of claim 1, wherein the tissue adhesive substrate provides a fiduciary marker for a closed-loop autofocussing mechanism.

5: A method of using a tissue adhesive substrate comprising:
adhering a tissue section to a tissue adhesive substrate comprising a glass substrate, a silane covalently bound to the glass substrate, and a carbon coating; and
contacting the adhered tissue section with one or more fluorescent dye-labeled antibodies.

6: The method of claim 5, wherein the adhered tissue section is contacted with four or more fluorescent dye-labeled antibodies.

7: The method of claim 5, wherein contacting the adhered tissue section with one or more fluorescent dye-labeled antibodies comprises:
applying a first set of one or more fluorescent dye-labeled antibodies to the adhered tissue section;
imaging the adhered tissue section;
i) treating the adhered tissue section in an elution solution;
ii) applying an additional set of one or more fluorescent dye-labeled antibodies to the adhered tissue section;
iii) imaging the adhered tissue section; and
repeating steps i), ii), and iii) four or more times.

8: The method of claim 7, wherein steps i), ii), and iii) are repeated 11 or more times.

9: The method of claim 8, wherein the tissue section remains adhered to the tissue adhesive substrate through all the steps of the method.

10: The method of claim 5, further comprising applying an electron microscopy contrast agent to the adhered tissue section and imaging the adhered tissue section using electron microscopy.

11: The method of claim 5, further comprising applying an electron microscopy contrast agent to the adhered tissue section prior to contacting the adhered tissue section with one or more fluorescent dye-labeled antibodies and imaging the adhered tissue section using electron microscopy after contacting the adhered tissue section with one or more fluorescent dye-labeled antibodies.

12: A method of using a tissue adhesive substrate comprising:
adhering a tissue section to a tissue adhesive substrate comprising a glass substrate, a silane covalently bound to the glass substrate, and a carbon coating;
contacting the adhered tissue section with one or more electron microscopy contrast agents; and
imaging the adhered tissue section using electron microscopy.

13: An embedded tissue adhesive substrate comprising:
a glass substrate; and
a silane covalently bound to the glass substrate, the silane comprising an aryl or an alkyl moiety, wherein the aryl or alkyl moiety is substituted with a moiety of the formula —NRaRb(Rc)n, where n is 0 or 1; Ra, Rb and Rc are independently H or a C1-C6 alkyl or two of Ra, Rb and Rc are taken together with the nitrogen to which they are attached to form a five or six-membered heterocyclic nitrogen containing ring; and a counterion X— is present when n is 1, wherein the tissue adhesive substrate is capable of retaining an ultrathin tissue section through at least 5 cycles of antibody staining and stripping without discernible damage to the tissue section.

14: The tissue adhesive substrate of claim 13, wherein the silane is 3-aminopropyltrimethoxysilane.

15: The tissue adhesive substrate of claim 13, wherein the silane is deposited on the glass substrate by vapor deposition.

16: The tissue adhesive substrate of claim 13, wherein the silane further comprises a hydroxyl or alkoxy moiety.

17: The tissue adhesive substrate of claim 16, wherein the silane further comprises a methoxy or ethoxy moiety.

18: The tissue adhesive substrate of claim 13, wherein the silane comprises a C1-C6 alkyl moiety substituted with a moiety of the formula —NRaRb where Ra and Rb are independently H and a C1-C6 alkyl.

19: The tissue adhesive substrate of claim 13, wherein the silane is of the formula (I):
Si(OR¹)₃(R²) (I)
wherein:
each R1 is independently H, a C1-C6alkyl, a bond to the glass substrate, or is taken together with an OR1 moiety from a neighboring silane to provide an ester cross-linked silane multimer; R2 is an aryl or an alkyl moiety, wherein the aryl or alkyl moiety is substituted with a moiety of the formula —NRaRb(Rc)n, where n is 0 or 1; Ra, Rb and Rc are independently H or a C1-C6 alkyl or two of Ra, Rb and Rc are taken together with the nitrogen to which they are attached to form a five or six-membered heterocyclic nitrogen containing ring; and a counterion X— is present when n is 1.

20: The tissue adhesive substrate of 19, wherein R2 is a C1-C6 alkyl substituted with a moiety of the formula —NRaRb(Rc)n, wherein: n is 0 or 1; Ra, Rb and Rc are independently H or a C1-C6 alkyl; and a counterion X— is present when n is 1.
